(19) United States
(12) Patent Application Publication
(10) Pub. No.: US 2012/0116982 A1
(43) Pub. Date: May 10, 2012

(54) METHOD AND SYSTEM FOR ESCALATING CONTENT OF DISCUSSIONS TO PARTICULAR MEMORY LOCATIONS

(75) Inventors: Norimasa Yoshida, Daly City, CA (US); Grant Anderson, San Francisco, CA (US); Etienne Girauday, San Francisco, CA (US); George Su, San Francisco, CA (US); Justin Lin, Coppell, TX (US); Park Kittipatkul, Foster City, CA (US); Vinodh Rajagopal, Sunnyvale, CA (US); Irina Sendyk, San Mateo, CA (US); Sriram Rangaraj, Sunnyvale, CA (US)

(73) Assignee: Salesforce. com. Inc., San Francisco, CA (US)

(21) Appl. No.: 13/151,784

(22) Filed: Jun. 2, 2011

Related U.S. Application Data
(60) Provisional application No. 61/350,904, filed on Jun. 2, 2010.

(51) Int. Cl. G06Q 10/00

(52) U.S. Cl. 705/304

(57) ABSTRACT

In this specification, online communities also referred to as forums, are used as a customer support tool. Users of the forum post questions and replies. In some embodiments users can vote on the replies. The authorized personnel can add an entry in a database based on the forum content. In an embodiment, such an entry could be in customer case management system when a question is not well answered or not answered at all and needs attention of customer support agent. In another embodiment, the entry could be in a knowledge base management system when a question is well answered and is considered to be potentially useful for many forum users. Any of the above embodiments can be used independently or together with any combination of other embodiments.

### CLAIM OF PRIORITY

This application claims the benefit of U.S. Provisional Patent Application 61/350,904 entitled METHOD AND SYSTEM FOR ANSWERS TO CASES ESCALATION, by Norimasa Yoshida et al., filed Jun. 2, 2010 (Attorney Docket No. SALEP0005P), the entire contents of which are incorporated herein by reference.

### CROSS REFERENCE TO RELATED APPLICATIONS

The following commonly owned, co-pending United States Patents and Patent Applications, including the present application, are related to each other. Each of the other patents/applications are incorporated by reference herein in its entirety:

U.S. Provisional Patent Application No. 61/350,904 entitled METHOD AND SYSTEM FOR ANSWERS TO CASES ESCALATION, by Norimasa Yoshida et al., filed Jun. 2, 2010 (Attorney Docket No. SALEP0005P); and

U.S. patent application Ser. No. 11/716,365 entitled METHOD AND SYSTEM FOR POSTING IDEAS, by Norimasa Yoshida et al., filed Mar. 8, 2007 (Attorney Docket No. 48-2), which is now U.S. Pat. No. 7,831,455; and

U.S. patent application Ser. No. 11/786,882 entitled METHOD AND SYSTEM FOR MANAGING IDEAS, by Norimasa Yoshida et al., filed Apr. 13, 2007 (Attorney Docket No. 48-3/042US), which is now U.S. Pat. No. 7,818,194; and

U.S. patent application Ser. No. 11/801,572 entitled METHOD AND SYSTEM FOR INTEGRATING IDEA AND ON DEMAND SERVICES, by Norimasa Yoshida et al., filed May 9, 2007 (Attorney Docket No. 48-4/043US), which is now U.S. Pat. No. 7,840,413; and

U.S. Provisional Patent Application No. 61/354,604 entitled METHODS AND SYSTEMS FOR DYNAMICALLY SUGGESTING ANSWERS TO QUESTIONS SUBMITTED TO A PORTAL OF AN ONLINE SERVICE, by Patrick McFarlane et al., filed Jun. 14, 2010 (Attorney Docket No. SALEP0030P); and

U.S. patent application Ser. No. ______ entitled METHODS AND SYSTEMS FOR DYNAMICALLY SUGGESTING ANSWERS TO QUESTIONS SUBMITTED TO A PORTAL OF AN ONLINE SERVICE, by Patrick McFarlane et al., filed ______ (Attorney Docket No. 48-51/429US); and

U.S. Provisional Patent Application No. 61/360,752 entitled METHODS AND SYSTEMS FOR SCORING AND RANKING ARTICLES IN AN ON-DEMAND SERVICES ENVIRONMENT, by Vinodh Rajagopal, filed Jul. 1, 2010 (Attorney Docket No. SALEP0034P); and

U.S. patent application Ser. No. ______ entitled METHOD AND SYSTEM FOR SCORING ARTICLES IN AN ON-DEMAND SERVICES ENVIRONMENT, by Vinodh Rajagopal, filed ______ (Attorney Docket No. 48-52/436US); and

U.S. Provisional Patent Application No. 61/402,576 entitled METHOD AND SYSTEM FOR PROVIDING SIMPLIFIED FORM FILLING IN AN ON-DEMAND SERVICE, by Nadia Naderi, filed Aug. 10, 2010 (Attorney Docket No. 48-46/463US); and

U.S. patent application Ser. No. 13/030,096 entitled METHOD AND SYSTEM FOR PROVIDING SIMPLIFIED FORM FILLING IN AN ON-DEMAND SERVICE, by Nadia Naderi, filed Feb. 17, 2011 (Attorney Docket No. 48-53/463US); and

U.S. Provisional Patent Application No. 61/351,620 entitled METHODS AND SYSTEMS FOR PROVIDING ANSWERS TO USERS OF A MULTI-TENANT DATABASE SYSTEM, by Norimasa Yoshida et al., filed Jun. 4, 2010 (Attorney Docket No. SALEP0004P); and

U.S. patent application Ser. No. ______ entitled METHOD AND SYSTEM FOR PROVIDING ANSWERS TO USERS OF A MULTI-TENANT DATABASE SYSTEM, by Norimasa Yoshida et al., filed ______ (Attorney Docket No. 48-54/384US); and

U.S. Provisional Patent Application No. 61/354,003 entitled METHODS AND SYSTEMS FOR ANALYZING SEARCH TERMS IN A MULTI-TENANT DATABASE SYSTEM ENVIRONMENT, by Olivier Y. Pin et al., filed Jun. 11, 2010 (Attorney Docket No. SALEP0012P); and

U.S. patent application Ser. No. ______ entitled METHODS AND SYSTEMS FOR ANALYZING SEARCH TERMS IN A MULTI-TENANT DATABASE SYSTEM ENVIRONMENT, by Francois Lopitaux et al., filed ______ (Attorney Docket No. 48-56/394US).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The specification generally relates to forums for sharing ideas.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Some forms of obtaining customer feedback are focus groups and user meetings. However, focus groups and user meetings can be expensive to run. Conventionally, applications, such as databases, file systems, word processors and the like, were delivered to the end users in the form of software. Feedback mechanisms for these products exist typically in the form of problem reports, quality surveys and the like.

With the advent of the web, however, software-like utility is increasingly delivered to users as a service. These so named “software as a service” approaches may include a group of end users, who may wish to use the service offering collaboratively, or who may wish to share their input as a community, making the old problem report or feedback survey cumbersome or unsatisfactory.

Accordingly, it is desirable to provide techniques enabling sharing ideas to improve service offerings.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 shows a block diagram of an embodiment of an application platform for conducting a forum having an algorithm for escalating content to a particular location;

FIG. 2 shows an operational flow diagram illustrating an embodiment of a user system method for escalating content to a particular location;

FIG. 3 shows an operational flow diagram illustrating an embodiment of a user system method for escalating content to a particular location;

FIG. 4 shows an operational flow diagram illustrating an embodiment of a user system method for escalating content to a particular location;

FIG. 5 shows an operational flow diagram illustrating an embodiment of a server side method for escalating content to a particular location;

FIG. 6 shows an operational flow diagram illustrating an embodiment of a method for determining which cases to escalate;

FIG. 7 shows an operational flow diagram illustrating an embodiment of a method for determining which cases to escalate;

FIG. 8 shows a screenshot of an embodiment of a question webpage;

FIG. 9 shows a screenshot of an embodiment of a question webpage displaying similar questions;

FIG. 10 shows a screenshot of an embodiment of a webpage displaying a posting acknowledgement;

FIG. 11 shows a screenshot 1100 of an embodiment of a webpage displaying a reply;

FIG. 12 shows a screenshot 1200 of an embodiment of a webpage displaying a reply acknowledgement;

FIG. 13 shows a screenshot 1300 showing an embodiment of a reply being voted;

FIG. 14 shows screenshot 1400 showing an embodiment of a second reply being voted and options to vote or promote the reply;

FIG. 15 shows a screenshot 1500 of an embodiment of a webpage displayed with the best answer vote;

FIG. 16 shows a screenshot 1600 of an embodiment of an article management webpage;

FIG. 17 shows a screenshot 1700 of an embodiment of a webpage displaying an article promotion;

FIG. 18 shows a screenshot 1800 of an embodiment of a webpage displaying a case webpage with case escalation;

FIG. 19 shows a screenshot 1900 of an embodiment of a webpage displaying a case webpage with case escalation;

FIG. 20 shows a screenshot of an embodiment of a webpage of a forum ready to accept a question from the user;

FIG. 21 shows a screenshot of an embodiment of a webpage of the forum with a question entered in the user interface;

FIG. 22 shows a screenshot of an embodiment of a webpage of the forum with similar questions displayed;

FIG. 23 shows a screenshot of an embodiment of a webpage of the forum where a user question is posted;

FIG. 24 shows a screenshot of an embodiment of a webpage of the forum in a webpage showing the posted question and answers;

FIG. 25 shows a screenshot of an embodiment of a webpage of the forum in a webpage showing an answer which has been voted as best;

FIG. 26 illustrates an embodiment of an environment within which the system for escalating content to a particular location may operate;

FIG. 27 illustrates an embodiment of elements of FIG. 26 and various possible interconnections between elements of the environment.

FIG. 28 shows a flowchart of an example of a method using the environment of FIG. 26.

FIG. 29 is a flowchart of an example of a method of making an environment of FIG. 26.

### DETAILED DESCRIPTION

### General Overview

Systems and methods are provided for escalating the content of a forum to particular locations, which may be in a database network system.

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing methods and systems for cases to escalate will be described with reference to example embodiments. In this specification a community is a group of users that share a common interest and tend to communicate with one another about that common interest. A community website is a website in which users share ideas that are related to the community. An on-demand community is a community website that is created by the tenant using pre-established tools specialized for creating communities. In an embodiment, the focus of the communities may be on on-demand enterprise communities, which are communities structured around a business' ecosystem: partners, customers, vendors, employees, etc.

In this specification the terms forum, web forum, and community website may be interchanged with one another to obtain different embodiments. Additionally, forum content may be used to refer to a question or questions and answers discussed in a forum. The forum contents may reside in a database. The forum may include various features and/or tools that are available to users and/or administrators. Some content may be placed initially on the forum at the launch of the website, which gives an initial significant value to the website that may be linearly proportional to the number of users that are able to view the content and that are expected to be interested in the content. Enabling user interaction with one another, via the posting of new ideas, the commenting on ideas, and/or participating in discussions causes the value of the website to increase in the community.

Traditional forums have focused on providing a meeting place for a virtual community of internet users who share common interest. However, forums can also be used for lowering costs in a business context by providing a cheaper avenue for customer service. Instead of calling into a call center where a human agent takes calls and answers questions, forums can provide a more scalable method where customers can help each other answer their own questions.

Generally, forums serve a similar function to customer support. However, there are questions that may come into a forum that may need to be escalated to a customer support agent for a variety of reasons. A few examples of such cases may be the importance of the issue, the severity of the customer's problem alluded to in the question, a question unanswered by the community, and/or the value of the customer, among other reasons.

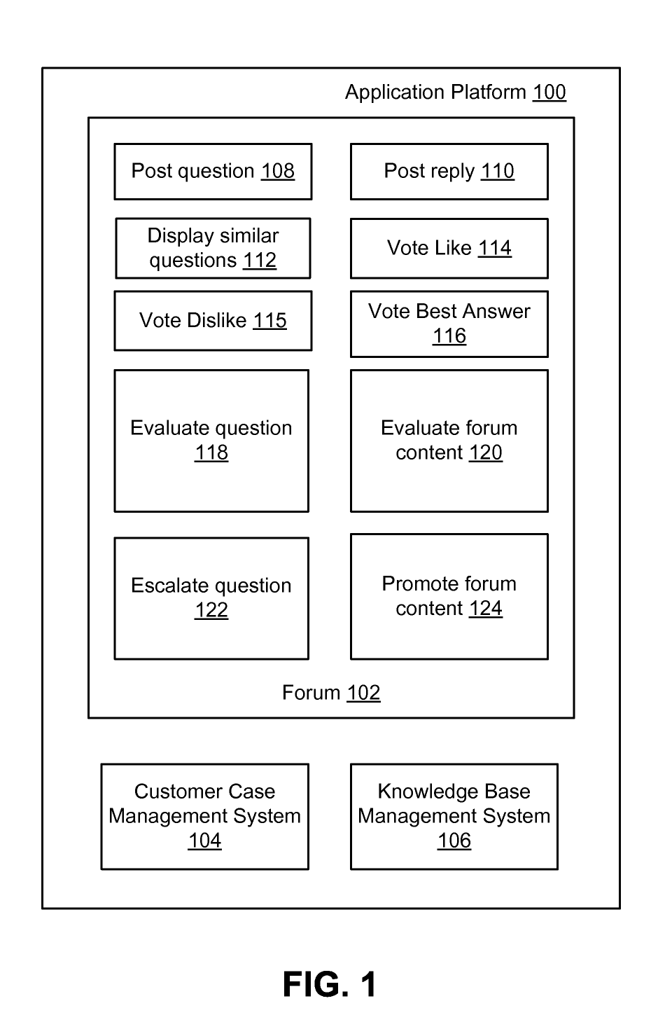

FIG. 1 shows an embodiment of an application platform 100. In an embodiment application platform 100 may host forum 102, customer case management system 104 and knowledge base management system 106. In an embodiment, forum 102 may have application programs, which include post questions 108, post reply 110, display similar questions 112, vote like 114, vote dislike 115, vote best answer 116, evaluate question 118, evaluate forum content 120, escalate question 122, and promote forum content 124 among others. In other embodiments application platform 100 may not have all of the elements or features listed and/or may have other elements or features instead of or in addition to those listed.

In an embodiment, application platform 100 is a platform for hosting a forum about a product or customer related topic. Application platform 100 facilitates organizing the questions and answers presented during the forum in a manner so that the information receives appropriate attention. In an embodiment, application platform 100 may have forum 102, which may be a community website and may have a common goal of discussing a product. Customer case management system 104 may be a database for managing customer support issues. Customer case management 104 may store information about specific issues that need to be resolved for specific clients, such as which issues have troubled which clients, how long ago the issue appeared, whether any action has been taken to resolve the problem, what has been done to resolve the issue, how well the action taken to resolve the problem worked. Knowledge base management system 106 may be a database of knowledge articles. Generally, knowledge articles are entered by customer support agents. The knowledge articles may include information that customers, customer care agents, and/or administrators are expected to find useful. The knowledge articles may come from forum 102, optionally knowledge articles may also come from elsewhere. For example, knowledge articles about a new product, such as tutorials or specific topics, may be placed in forum 102 by the developer at the time that a product is released. Post question algorithm 108 presents a user interface to enter a question in forum 102. Once a question is presented to the forum 102, the question is visible to other users and the other users can reply to the posted question. Post reply 110 may be an algorithm with a user interface to post a reply to a question. Multiple users can reply to the question. Display similar questions 112, may be an algorithm for searching the forum 102 for similar questions which were presented earlier in the forum and display them. The user has the option of browsing the similar questions or presenting the question to the forum. Apart from answering questions, users can vote whether they like the posted answers. Vote like 114 may be an algorithm for voting whether a user likes the answer. In an alternative embodiment, the users can vote on questions in addition to, and/or independently from, voting on answers.

If the authorized personnel considers that a particular question has been well addressed, the authorized personnel can vote as best answer. Vote best answer 116 may be an algorithm for voting an answer as best answer. In this specification authorized personnel may be any person authorized to escalate or promote an article. For example, in an embodiment, the authorized personnel may include one or more moderators of the forum, one or more administrators of the system hosting the forum, owner of the question and customer support agents, and/or other authorized personnel.

Regarding evaluate question 118, in an embodiment, an integrated solution is provided whereby a forum question can be escalated into a customer case management system 104 by authorized personnel. Evaluate question 118, is an algorithm for evaluating the question for escalation to customer case management system 104.

Regarding, algorithm evaluate forum content 120, when a question is well discussed by the forum members, the forum content can become a valuable asset. In this specification, forum content refers to the questions and answers associated with the question. Evaluate forum content 120 is an algorithm for evaluating the forum content for promoting to knowledge base management system 106. The authorized personnel evaluates the forum content to promote the forum content to knowledge base management system 106.

Escalate question 122 escalates a question to customer case management system 104. Escalation is the process of adding information to a location where the information may be given more attention. The word “escalate” (or any of the conjugations of escalate) is used instead of “add” to indicate that the information is given a higher degree of importance and that the information is being added to a location where the information will receive attention. Escalation 122 generates a case in the customer case management system 104, attaching the question to the case so that the question and the case can be tracked as a pair and finally informing the forum that a case has been created from the forum.

Promote forum content 124 promotes forum content, so that the content is given a higher credibility. The words promote and escalate are used in a similar fashion, except in this specification, the word “promote” in conjunction with the “knowledge base” and the word “escalate” is used in conjunction with the “customer case management,” but otherwise both the words “promote” and “escalate” are used for the same meaning. Promoting forum content may be performed by generating an entry in the knowledge base management system 106 from the forum content. The entry may be attached to the forum content for further tracking and informing the forum members that a new article is added to the knowledge base management system 106 from the forum content.

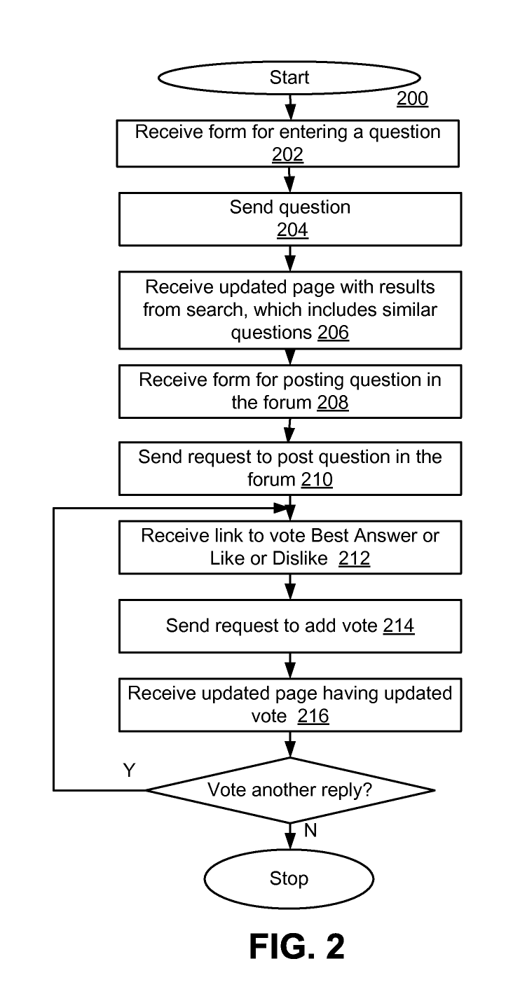

Users who post questions in the forum can read posted replies, vote to like or dislike as well as vote an answer as best. FIG. 2 shows a flow diagram where the system receives a question, updates the webpage with a similar question, receives and posts a reply and receive votes to like or dislike a reply. In this specification the word “post” as in “posting” a question, answer, or comment refers to submitting a question, answer, or comment to be displayed on a community website.

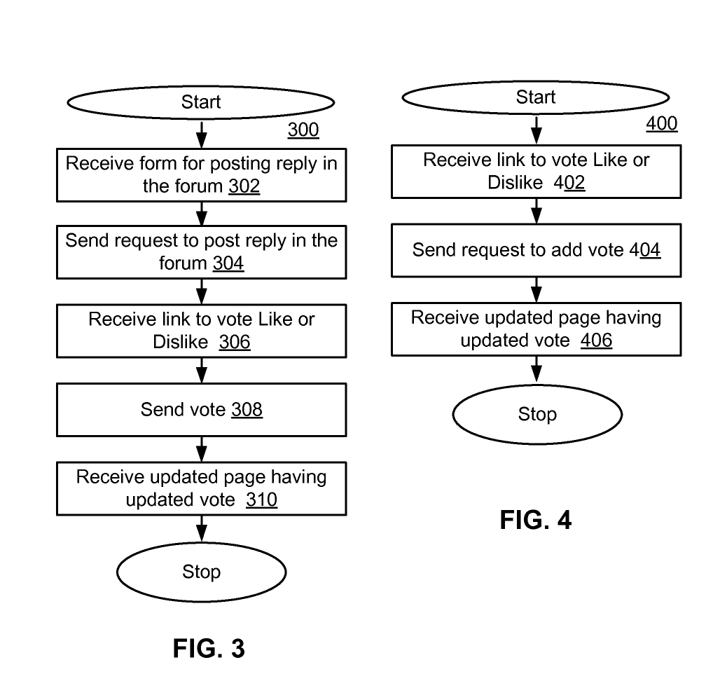

Users who do not post a question can read replies and vote to like or dislike a reply. FIG. 3 shows a flow diagram where the system receives and posts a reply and receives votes to like or dislike a reply.

Users who do not post a question can only read posted replies and/or vote. FIG. 4 shows a flow diagram where the system can receive votes to like or dislike a reply.

### USER SYSTEM METHOD OF ESCALATING QUESTIONS TO CASES AND/OR PROMOTING REPLIES TO KNOWLEDGE ARTICLE

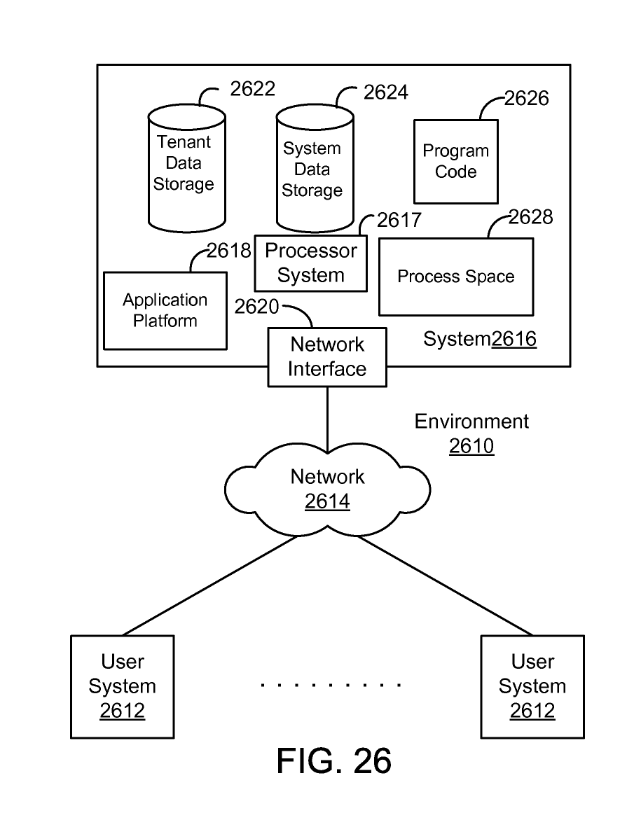

FIG. 2 shows an operational flow diagram illustrating method 200, which is a method implemented by the user system in escalating content to a particular location. Method 200 illustrates a method implemented from the user system posting the question. In method 200, the user system can receive a link for posting a question, post a question in the forum as well as vote on the replies. In step 202, in an embodiment, the user system (will be discussed further in conjunction with FIG. 26) receives a form for entering a question in the forum. In step 204, the user sends a question. In an embodiment, as part of the sending of the question of step 204, the user system sends a request to the server (will be discussed further in conjunction with FIG. 26) for a page having a field for entering a question. After receiving the question from the user in the field for the question, the user system sends the question. In step 206, the user system (will be discussed further in conjunction with FIG. 26) receives information for updating the current webpage, so that the updated webpage shows search results related to the question sent. The search results may include a list of one or more similar questions or an indication that no similar questions were found. In an embodiment, the similar questions may be questions that were posted earlier in the forum. In step 208, the user system receives a form for posting the question in the forum from the server. In step 210, as a result of the link being activated, the user system sends a request to post the question in the forum. In step 212, the user system receives a link to vote. Step 212 may involve displaying at least three different voting options, which may include best answer, like, or dislike. Note that step 210 does not necessarily directly lead to step 212. Between steps 210 and 212, a different user (but not necessarily different) must post a reply. Then the user who posted the question may return to the page and vote on the reply. In step 214, the user system sends a request to the server to record the vote (which may trigger the server to compute the total votes). Step 214 may involve the user system receiving a selection of one of the links (e.g., which may include best answer, like or dislike vote, and/or other links). The user may use the best answer option to indicate that the user believes that the answer is the best answer of those posted and/or the user may indicate that the user likes or dislikes the answer by choosing the like or dislike link, respectively. In step 216, the user system may receive information for updating the current web page from the server so that the updated web page shows the new vote. Steps 212-216 may be repeated multiple times before the user ends the process.

In an embodiment, each of the steps of method 200 is a distinct step. In other embodiments, method 200 may not have all of the above steps and/or may have other steps in addition to or instead of those listed above. The steps of method 200 may be performed in another order. Subsets of the steps listed above as part of method 200 may be used to form their own method. In an embodiment, there could be multiple instances of method 200.

FIG. 3 shows an operational flow diagram illustrating method 300, which is a method implemented by the user system in escalating content to a particular location. In method 300, the user system can post replies to questions in the forum as well as vote like or dislike on the replies. In step 302, in an embodiment, the user system (the user system will be discussed further in conjunction with FIG. 26) receives a form for entering a reply to a question in the forum. The user system may receive links for performing many other actions along with the link for entering a reply. The user system waits to receive input from the user. In step 304, the user system sends a reply. As part of step 304, the user system may receive input from the user activating the link, such as a selection of the link. The reply sent by the user system may be in response to receiving a selection of the link from the user. In an embodiment, as part of the sending of the answer of step 304, the user system sends a request to the server (the server will be discussed further in conjunction with FIG. 26) for a page having a field for entering an answer to a question. In step 306, the user system receives a field for entering a text as an answer to the questions and may also receive a link to vote. Step 306 may involve displaying two voting options, which may include an option to vote like or dislike, depending on whether the user likes or dislikes the answer. Then the user system may wait for user input. In step 308, the user system receives a selection or other indication of a vote, and sends a request to the server to record the vote (which may trigger the server to compute the total votes). Step 308 may involve the user system receiving a selection of one of the two links (like or dislike) as a vote (the user may indicate that the user likes or dislikes the answer by choosing the like link or dislike link, respectively). In step 310, the user system may receive information for updating the current webpage from the server so that the updated webpage shows the new vote.

In an embodiment, each of the steps of method 300 is a distinct step. In other embodiments, method 300 may not have all of the above steps and/or may have other steps in addition to or instead of those listed above. The steps of method 300 may be performed in another order. Subsets of the steps listed above as part of method 300 may be used to form their own method. In an embodiment, there could be multiple instances of method 300.

FIG. 4 shows an operational flow diagram illustrating method 400, which is a method implemented by the user system in escalating content to a particular location. The user system in this embodiment may decide to only vote on the reply without replying to a question. In method 400, the user system can vote like or dislike on the replies. In step 402, the user system receives a link to vote. Step 402 may involve displaying two voting options, which may include like or dislike. Step 402 may be the same as step 306 (FIG. 3) described above. In step 404, the user system sends a request to the server to record the vote (which may trigger the server to compute the total votes). Step 404 may involve the user system receiving a selection of one of the two links to like or dislike a vote. Step 404 may be the same as step 308 describe above (FIG. 3). In step 406, the user system may receive information for updating the current webpage from the server so that the updated webpage shows the new vote. Step 406 may be the same as step 310 describe above (FIG. 3).

In an embodiment, each of the steps of method 400 is a distinct step. In other embodiments, method 400 may not have all of the above steps and/or may have other steps in addition to or instead of those listed above. The steps of method 400 may be performed in another order. Subsets of the steps listed above as part of method 400 may be used to form their own method. In an embodiment, there could be multiple instances of method 400.

### SERVER SIDE METHOD OF ESCALATING QUESTIONS TO CASES AND/OR PROMOTING REPLIES TO KNOWLEDGE ARTICLES

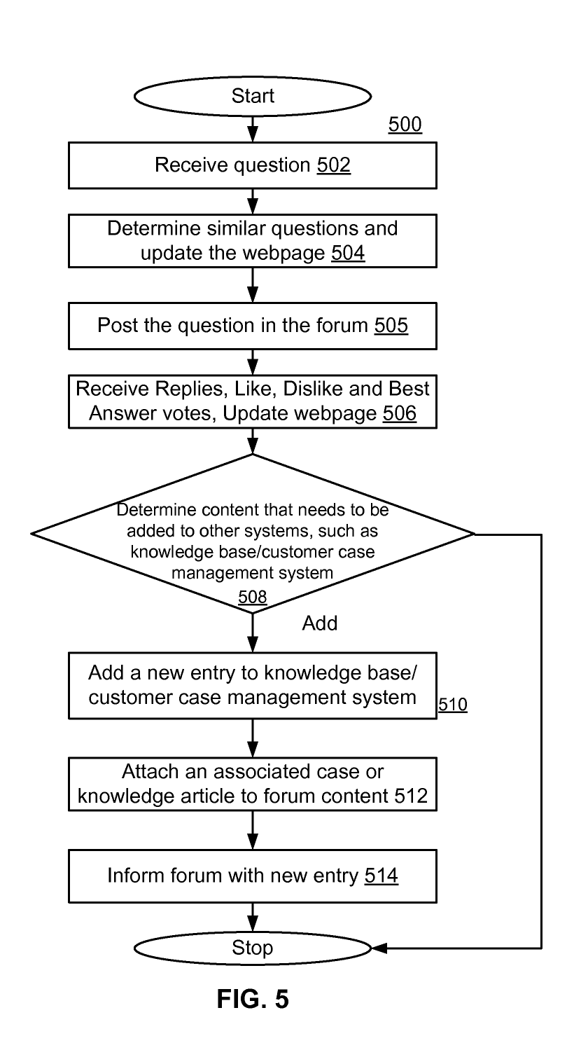

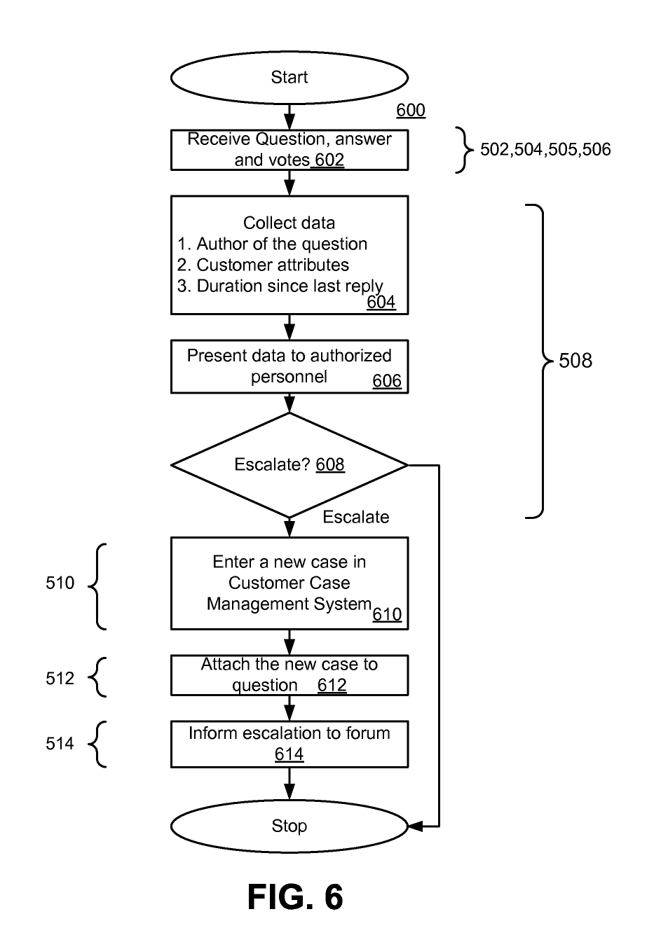

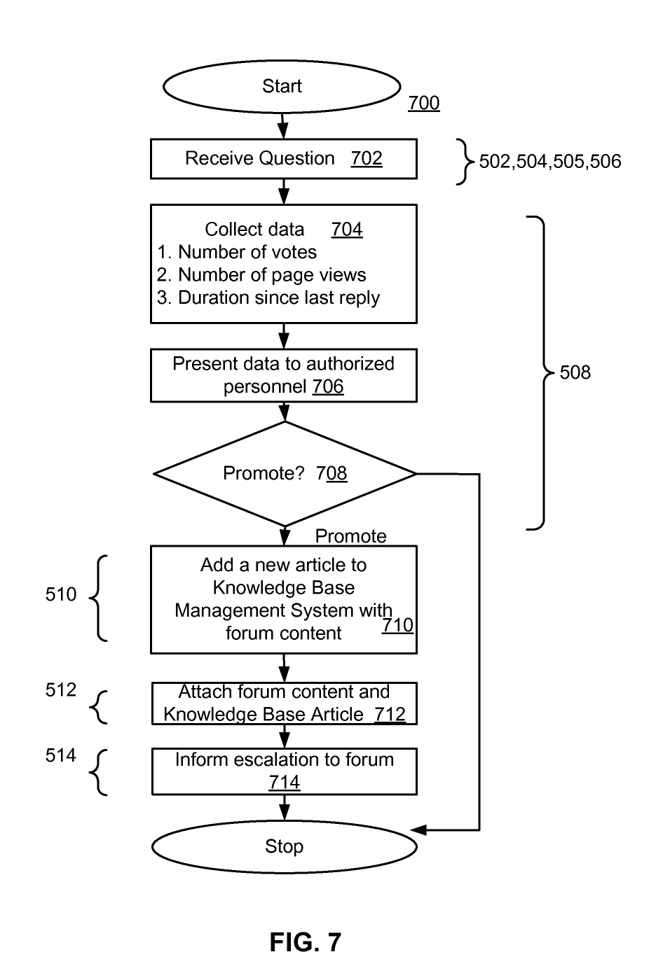

FIG. 5 shows an operational flow diagram of method 500 illustrating a server side method for escalating/promoting forum content to customer case management system 104 or knowledge base management system 106 in an embodiment. FIG. 5 is a generic flow diagram of adding an entry from the forum and escalating/promoting the entry to a specialized database related to the forum. Specific examples of method 500 are discussed in conjunction with FIGS. 6 and 7. Specifically, FIG. 6 shows the flow diagram of escalation to customer case management system and FIG. 7 shows the flow diagram of promotion to knowledge base management system in an embodiment. The application platform resides in the system (which will be discussed in conjunction with FIG. 26). All application programs reside in the application platform. The application platform is responsible for processing all the queries that originate in the user system. In step 502, the server (which will be discussed in conjunction with FIG. 26) receives the question, from the user machine, which was entered by the user system. In step 504, the server parses the question and determines whether there are any similar questions that were discussed earlier in forum 102 and updates forum 102. In step 505, the user system has the option of posting the new question or viewing similar questions which is was displayed in step 504. Selecting the similar question can cause a webpage to appear with similar question and answers. Selecting the continue button causes the server to post the question in forum 102 and waits for input from the user system. In step 506, the server receives answers and/or votes and finally updates forum 102. In decision box 508, the authorized personnel determine whether there is forum content that needs to be added to one of the databases, such as customer case management system 104, knowledge base management system 106, and/or any other systems.

A new entry is added to the customer case management system 104 by escalation. Escalation to customer case management system 104 is the process of creating a new case in customer case management system 104 with the question from forum 102. The second step in escalation involves attaching the question to the case for the purposes of tracking The final step in escalation may be informing forum 102 that a new case has been created with the forum content.

A new entry is added to knowledge base management system 106 by promotion. The first step in promoting to the knowledge base management system 106 may include creating a new article in the knowledge base management system 106 that includes the forum content. The second step may involve attaching the forum content to the new article and the final step may be informing the forum that a new article has been added to the knowledge base.

In step 510, a new entry is added to database, which optionally may involve adding a record for the entry in a relational database. In step 512, forum content may be attached to the new entry in the database, so that customer support staff as well as forum members can track the entry. In step 514, forum 102 is informed of the new entry in the database. If forum content is not added to the database, then the forum content remains in the forum. Steps 510, 512 and 514 constitute the escalation or promotion of the forum content.

In an embodiment, each of the steps of method 500 is a distinct step. In other embodiments, method 500 may not have all of the above steps and/or may have other steps in addition to or instead of those listed above. The steps of method 500 may be performed in another order. Subsets of the steps listed above as part of method 500 may be used to form their own method. In other embodiments, there could be multiple instances of method 500.

### SERVER SIDE METHOD OF ESCALATING CASES TO CUSTOMER CASE MANAGEMENT SYSTEM

FIG. 6 shows an operational flow diagram of method 600 illustrating an embodiment of determining whether to escalate a case to customer case management system 104. In step 602, the server receives the question, determines if there are any similar questions which were earlier discussed in the forum, posts the question to the forum, and receive answers and votes from the users. Step 602 may comprise of steps 502, 504, 505 and 506 (which were discussed in conjunction with FIG. 5). In step 604, the system collects information necessary to decide escalation to customer case management system 104. Some of the data used to determine escalation may be the author of the question, customer attributes, and duration since last reply and may be available in the multi-tenant database system. If a question has not been answered or not properly addressed in the forum, then the question is a candidate for escalation to customer case management system so that the customer case agents can provide a solution to the question. The author of the question may be another factor in considering escalation. If the author is a customer who has experience in using the product, then the question asked may be such that it needs extra attention. Customer attributes may include tenant profile which may be indicative of the action that needs to be taken. If the question has not received replies for a period of time, then the question may be escalated so that it can be addressed by the customer support agents. In step 606, the data collected in step 604 may be presented by the server to the authorized personnel to evaluate escalation. In decision box 608, the server waits for input from the authorized personnel. If the server receives input from the authorized personnel requesting to escalate a question to customer case management system 104, then the system proceeds to step 610. Steps 604, 606 and 608 perform the step of 508(which was discussed in conjunction with FIG. 5). In step 610, in response to the request received, a new case is created in customer case management system 104. The question posted in the forum is entered in the customer case management system 104, which optionally may include creating a record in a database that includes the content of the question posted to the forum. Step 610 may be the same as step 510 (which was discussed in conjunction with FIG. 5). In step 612, the question is attached to the new case to enable tracking the case and question together. Step 612 may be the same as 512 (which was discussed in conjunction with FIG. 5). In step 614, the server informs forum 102 about the new case by displaying a message along with the question. If the question is not escalated, no new case is entered in the customer case management system and the question remains in the forum. Step 614 may be the same as 514 (which was discussed in conjunction with FIG. 5).

In an embodiment, each of the steps of method 600 is a distinct step. In other embodiments, method 600 may not have all of the above steps and/or may have other steps in addition to or instead of those listed above. The steps of method 600 may be performed in another order. Subsets of the steps listed above as part of method 600 may be used to form their own method. In an embodiment, there could be multiple instances of method 600.

### SERVER SIDE METHOD OF ESCALATING CASES TO KNOWLEDGE BASE SYSTEM

FIG. 7 shows an operational flow diagram of method 700 determining cases to escalation in knowledge base management system 106 in an embodiment. In step 702, the server receives the question, determines if there are any similar questions that were discussed in forum 102, posts the question to forum 102 and receives answers and votes from the users. Step 702 may comprise of steps 502, 504, 505 and 506 (which were discussed in conjunction with FIG. 5). In step 704, the system may collect information necessary to decide escalation to knowledge base management system 106. Some of the data used to determine escalation are number of votes received, number of page views and duration since last reply. If a question is well answered and considered useful then such a question and answer is a possible candidate for promotion to the knowledge base. If a question and/or answer are viewed many times, then it can be an indication that the question and answer is important or useful for forum users.

In step 706, the collected data may be presented by the server to authorized personnel to evaluate promotion. In decision box 708, the server waits for input from the authorized personnel. If the server receives input from the authorized personnel requesting to promote a question and answer to knowledge base management system 106, then the system proceeds to step 710. Steps 704, 706 and 708 perform the step of 508 (which was discussed in conjunction with FIG. 5). In step 710, a new article is created in the knowledge base management system 106 with the forum content if the authorized personnel decide to promote the forum content. Step 710 may be the same as step 510 (which was discussed in conjunction with FIG. 5). In step 712 the forum content is attached to the new article in the knowledge base to enable tracking Step 712 may be the same as step 512 (which was discussed in conjunction with FIG. 5). In step 714, the new article is reported in forum 102. Step 714 may be the same as step 514 (which was discussed in conjunction with FIG. 5). If the forum content is not escalated, no new article is added to the knowledge base management system and the forum content is left in the forum.

In an embodiment, each of the steps of method 700 is a distinct step. In other embodiments, method 700 may not have all of the above steps and/or may have other steps in addition to or instead of those listed above. The steps of method 700 may be performed in another order. Subsets of the steps listed above as part of method 700 may be used to form their own method. In an embodiment, there could be multiple instances of method 700.

### SCREENSHOTS

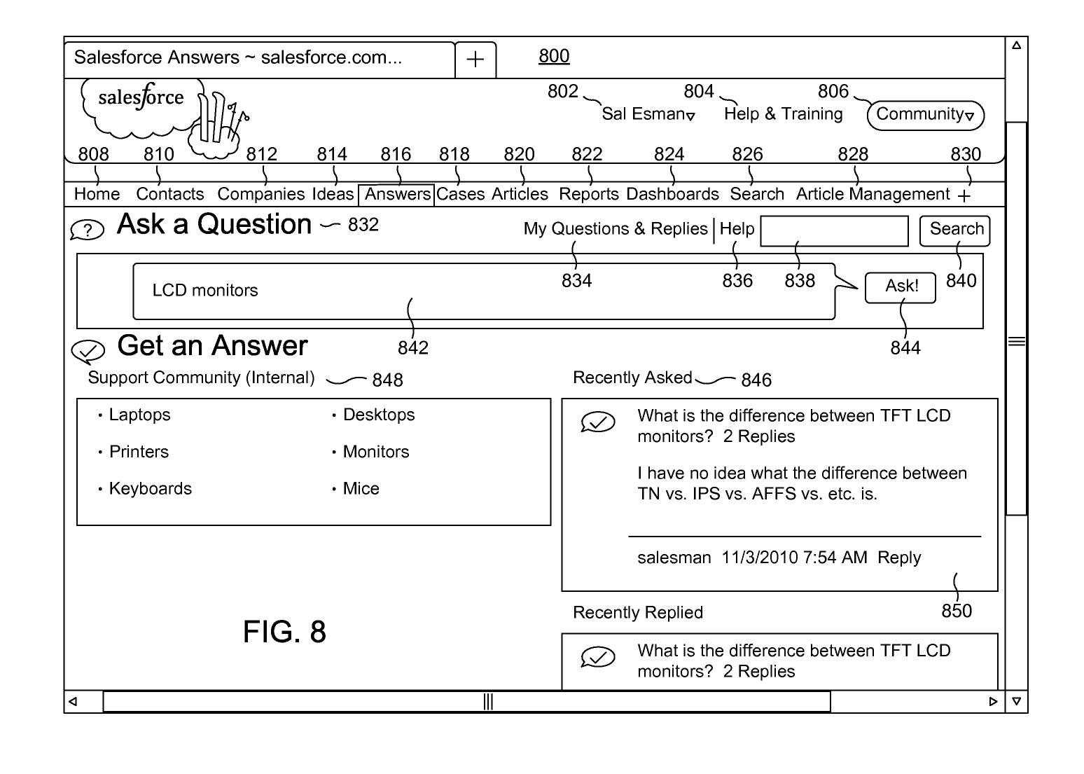

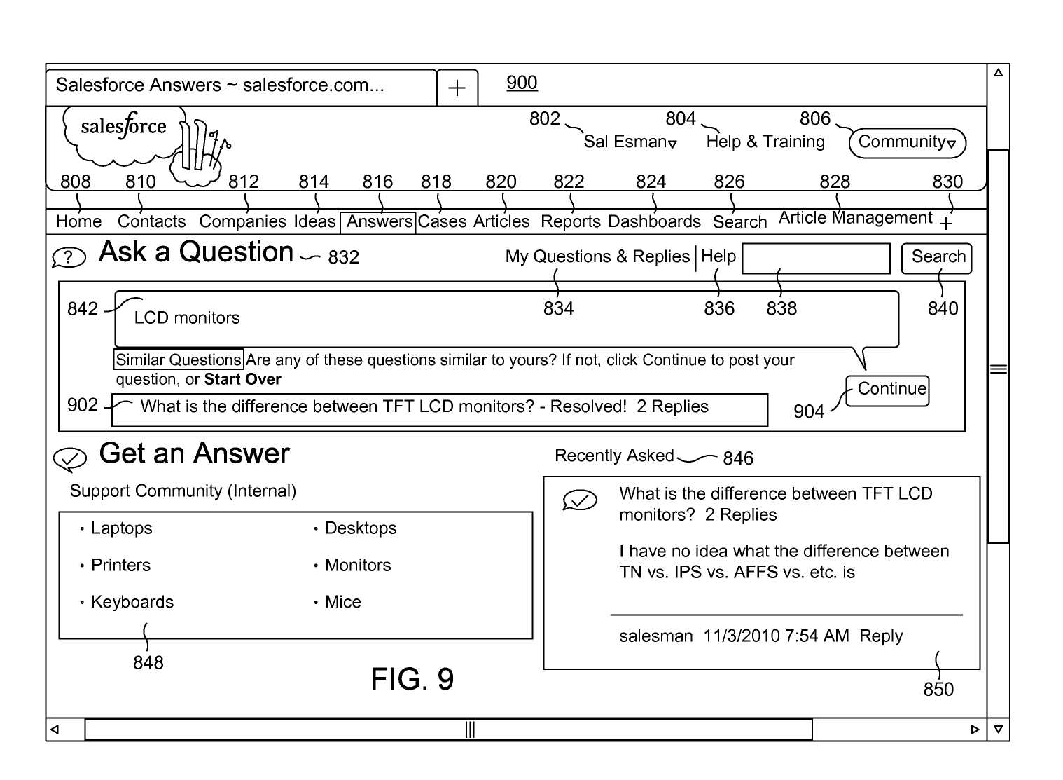

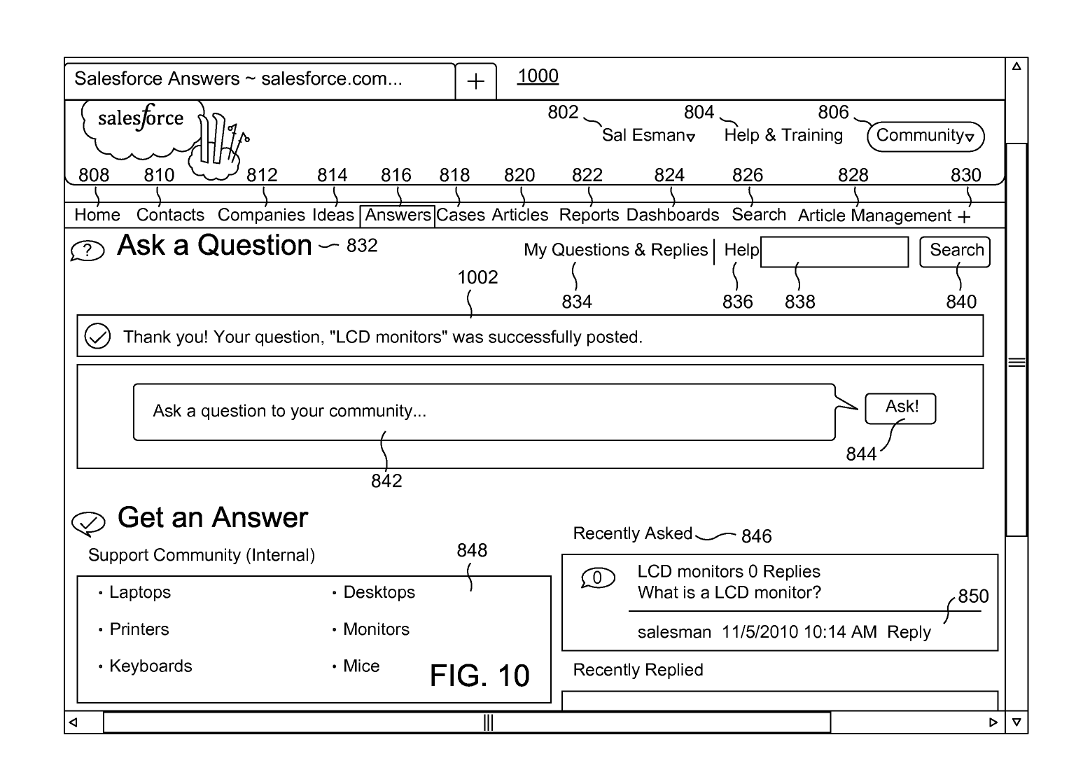

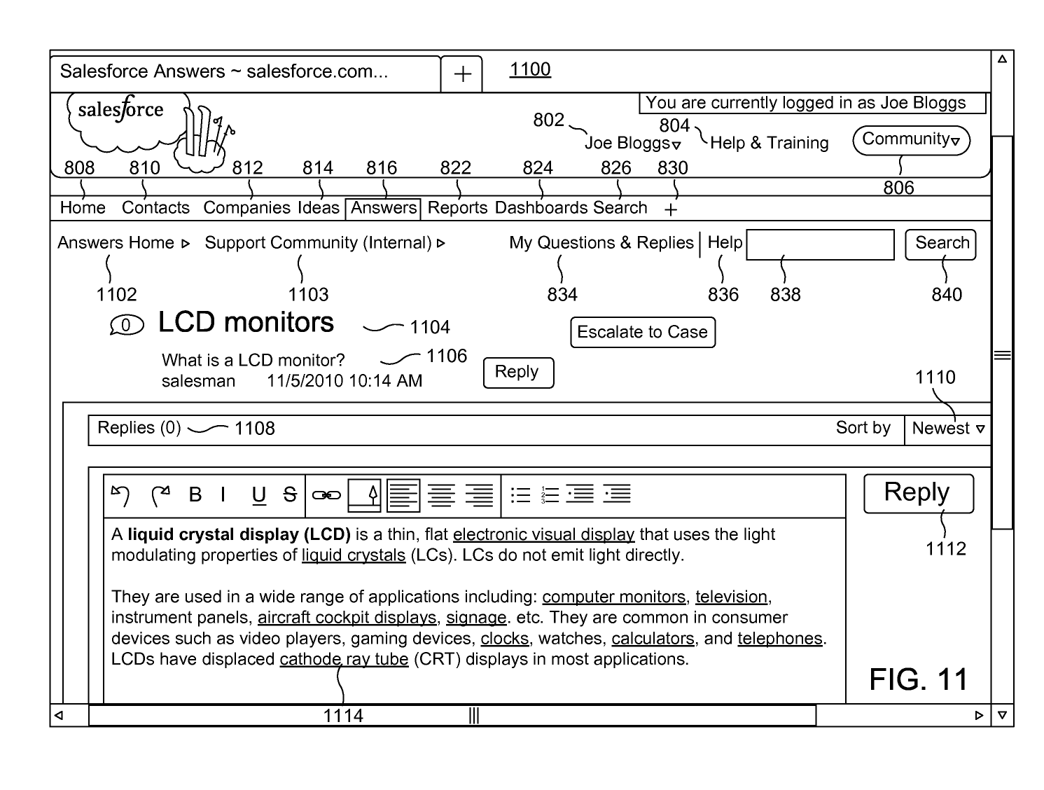

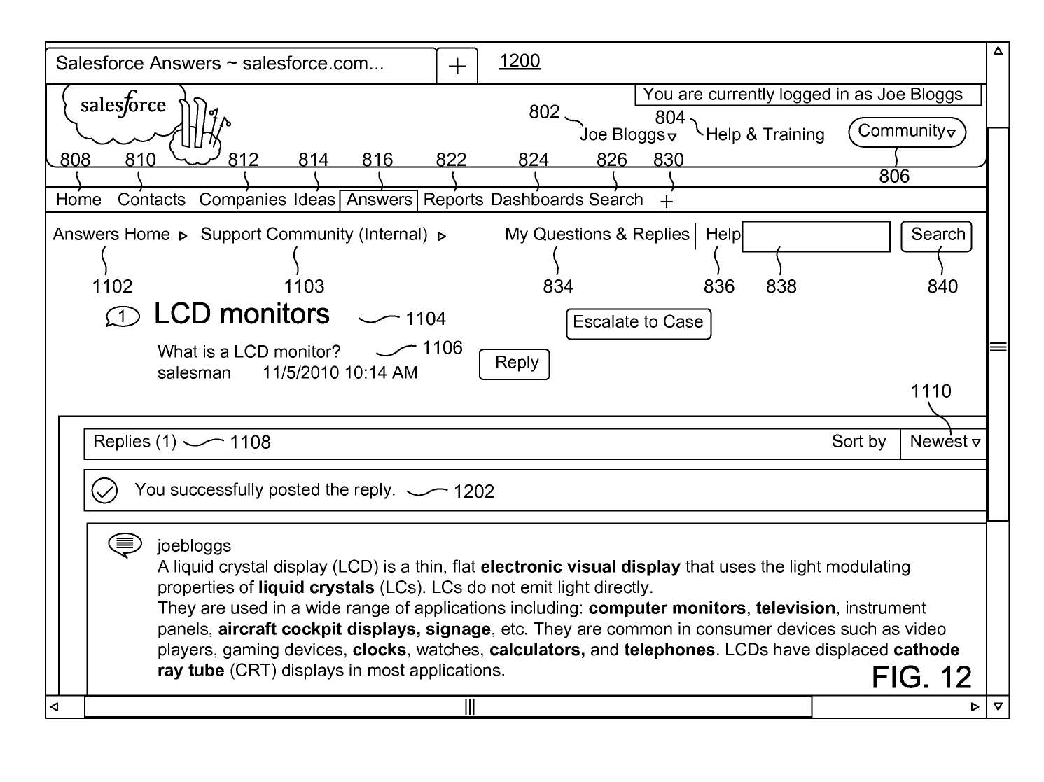

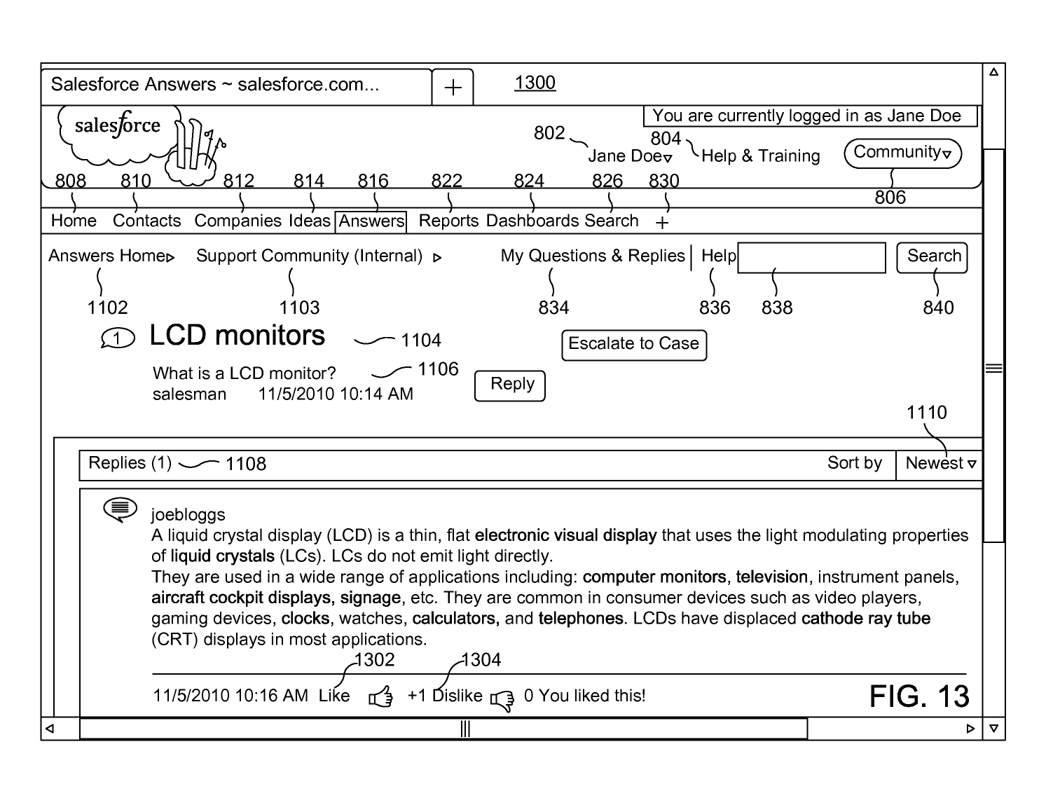

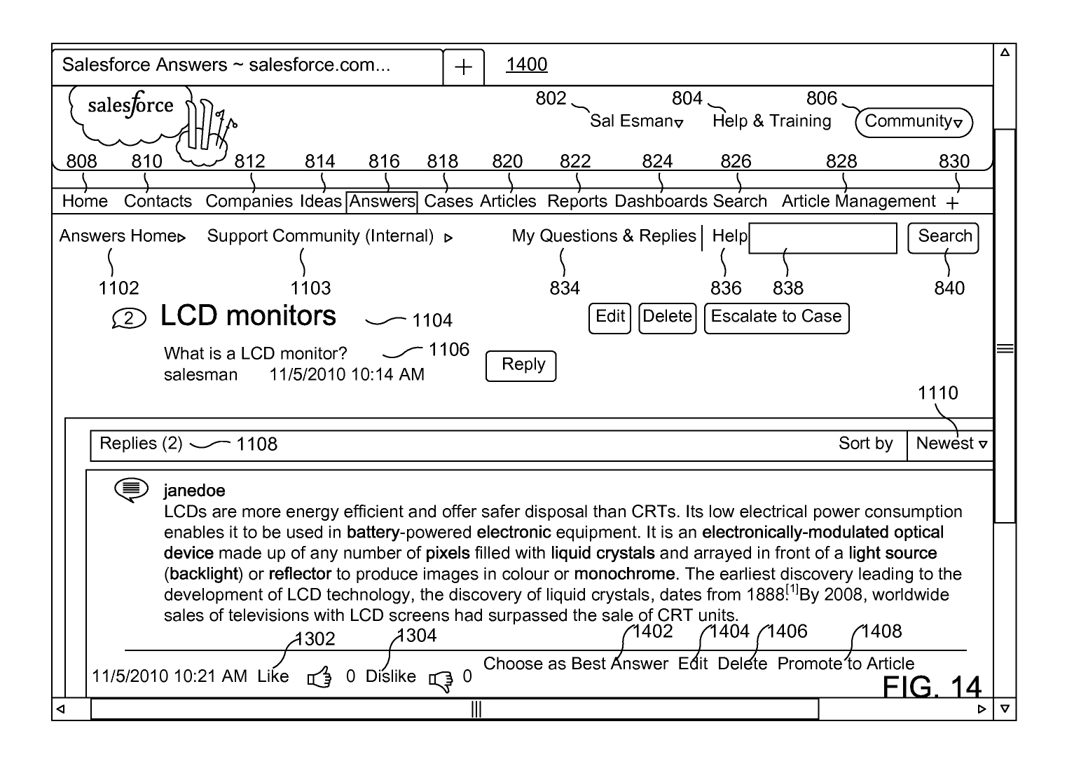

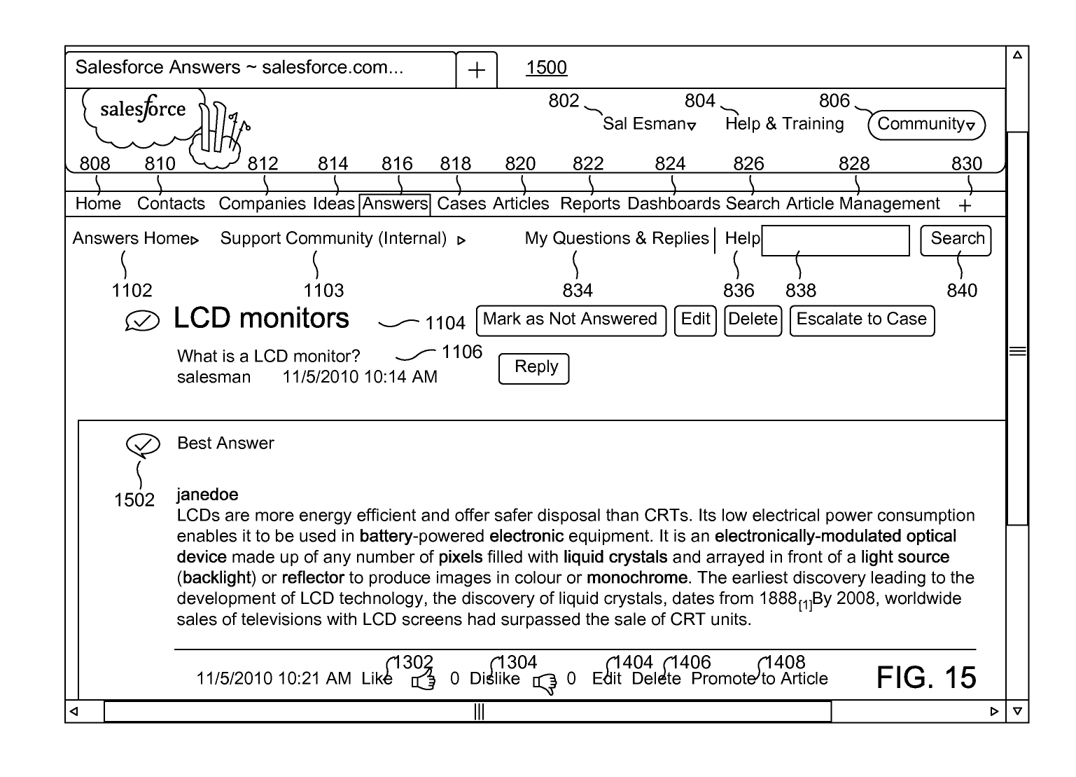

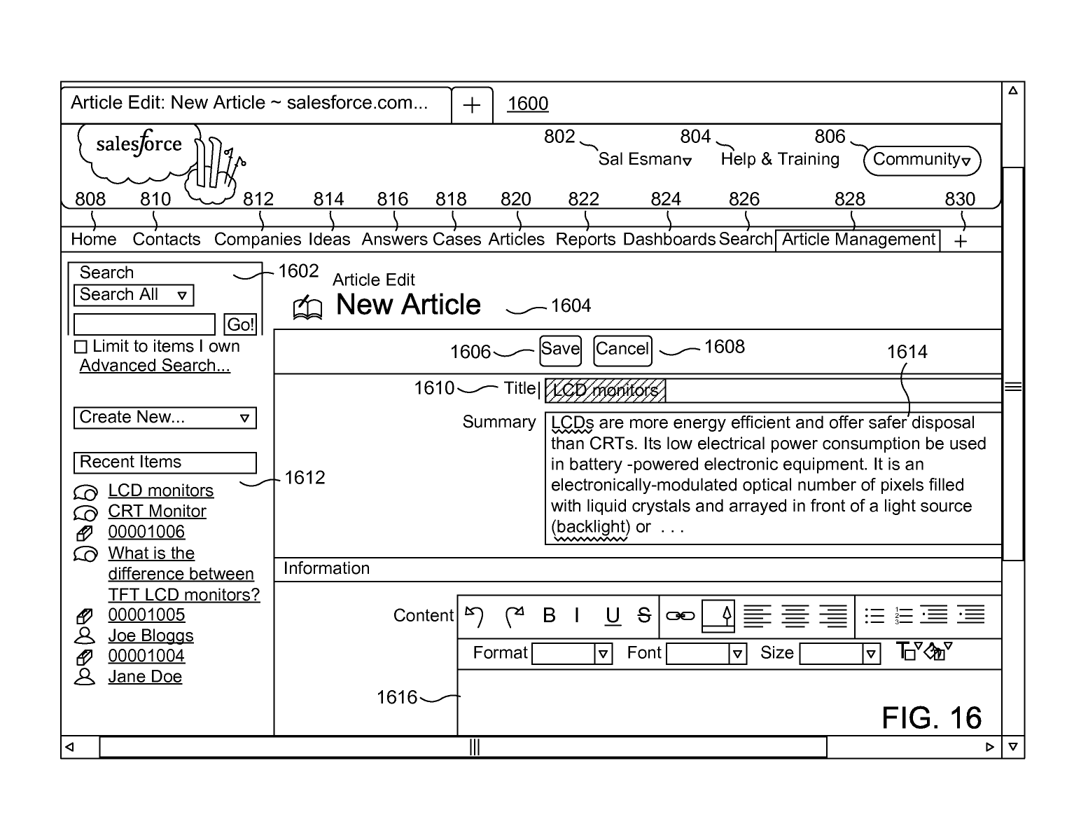

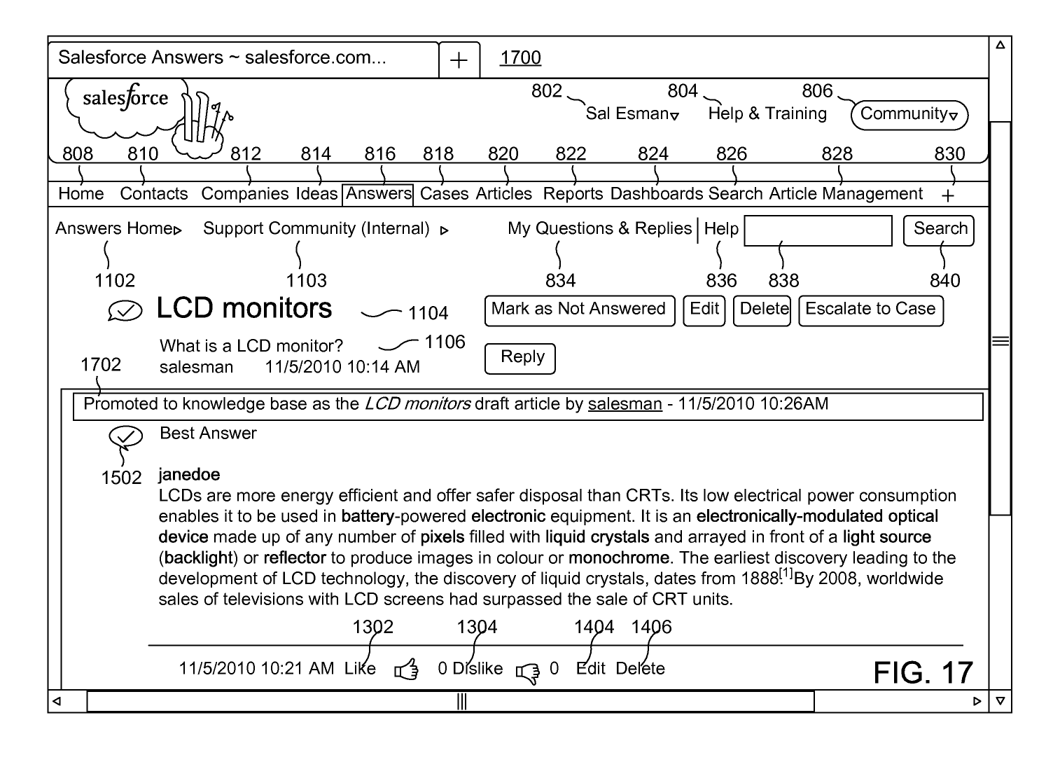

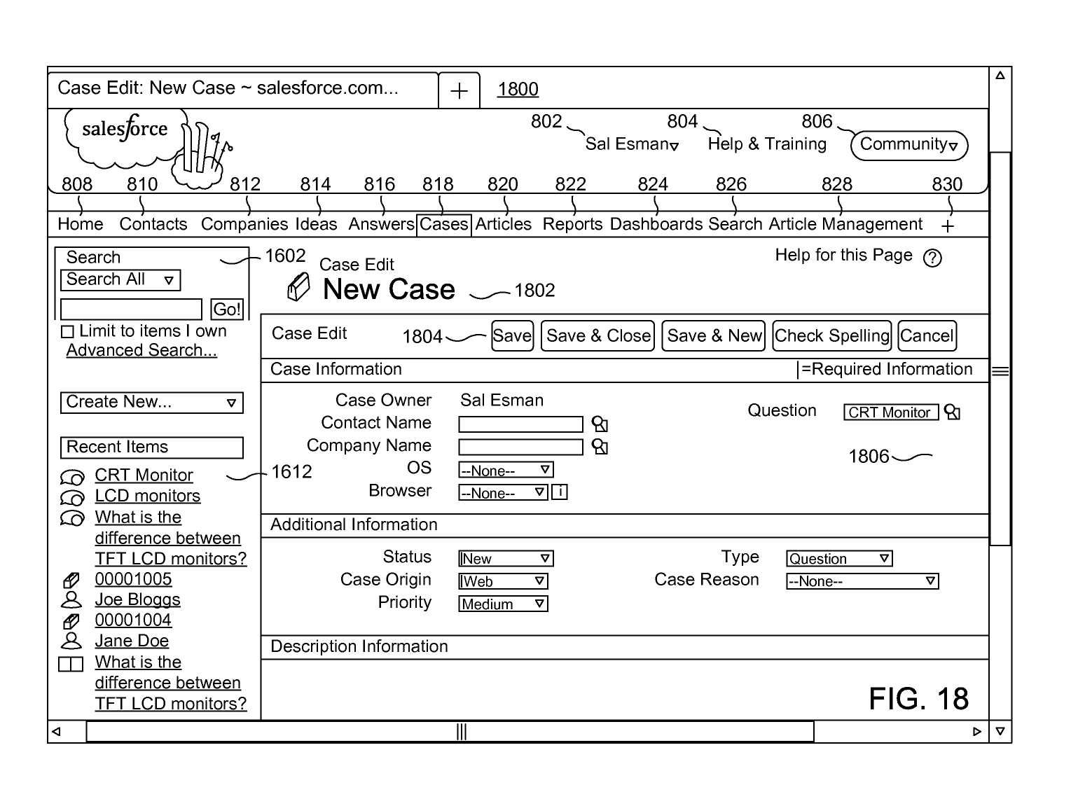

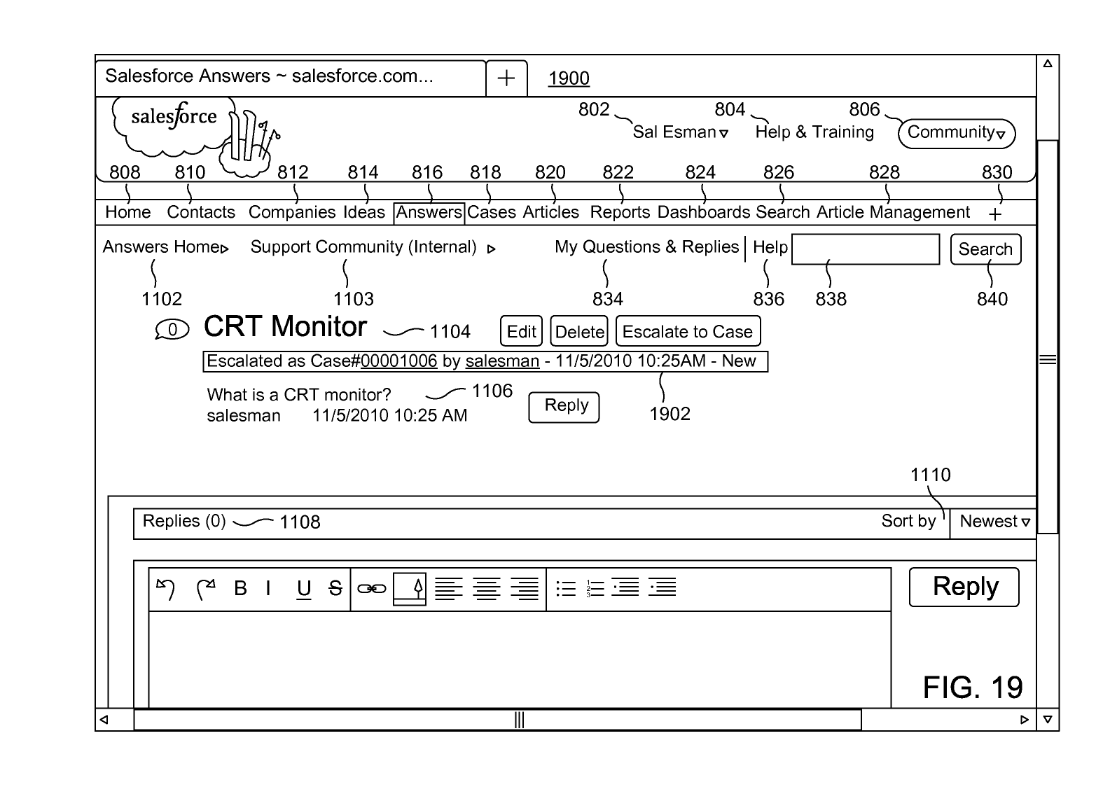

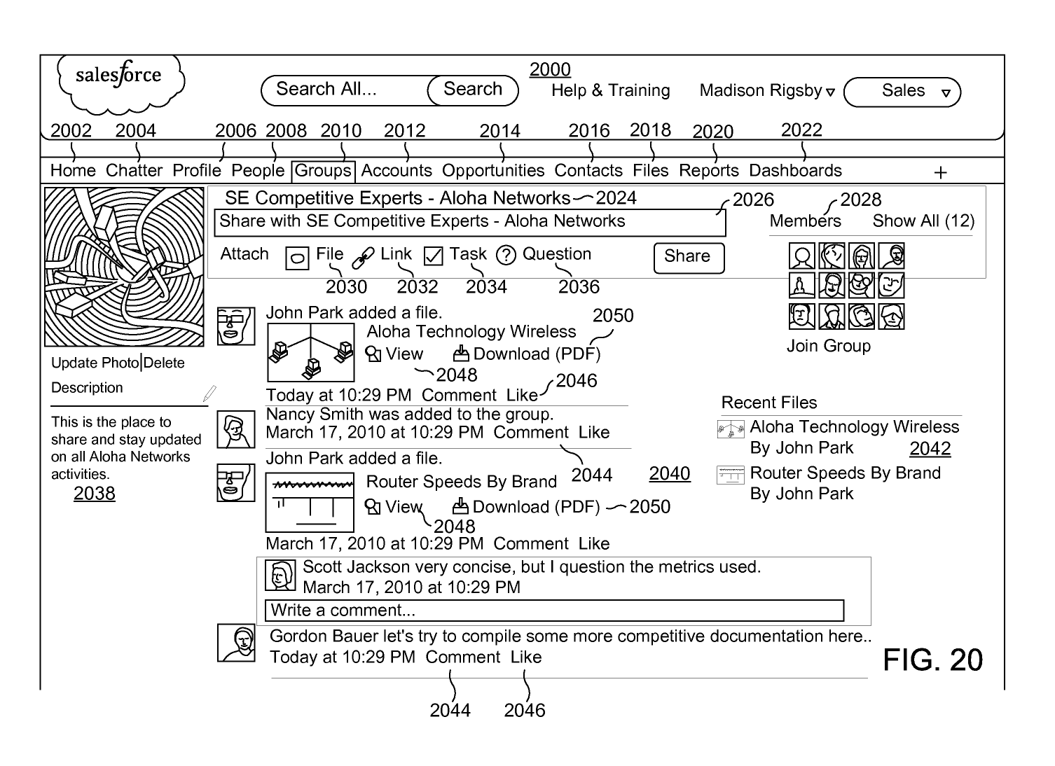

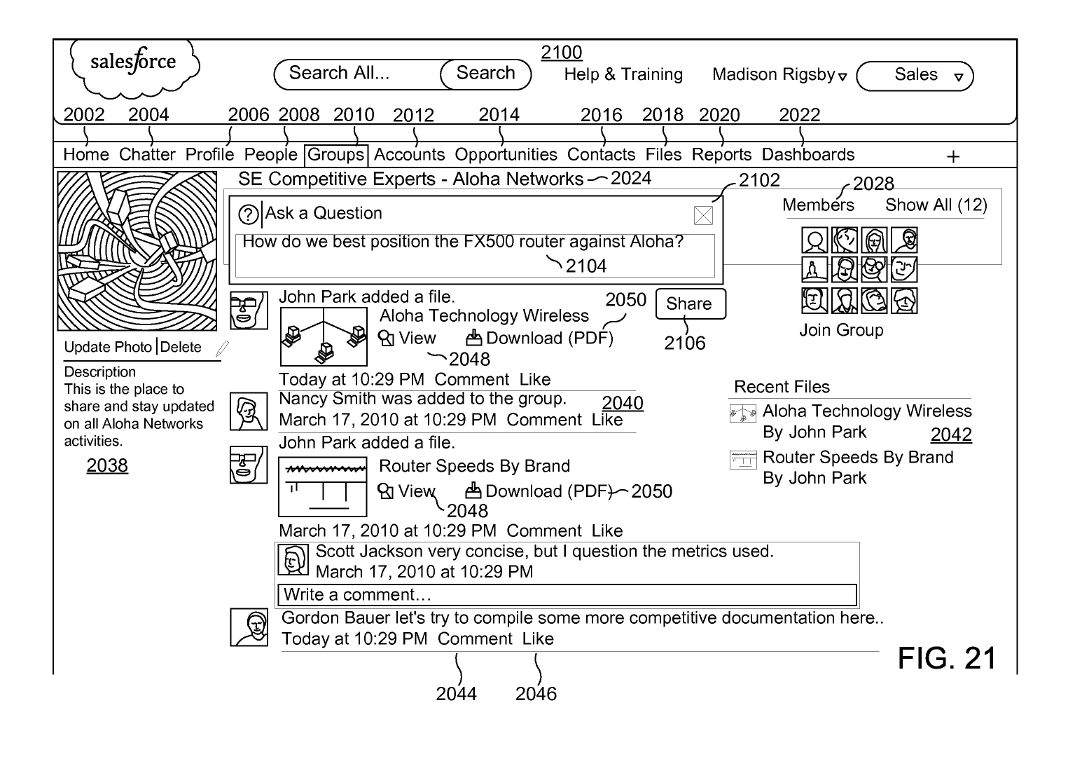

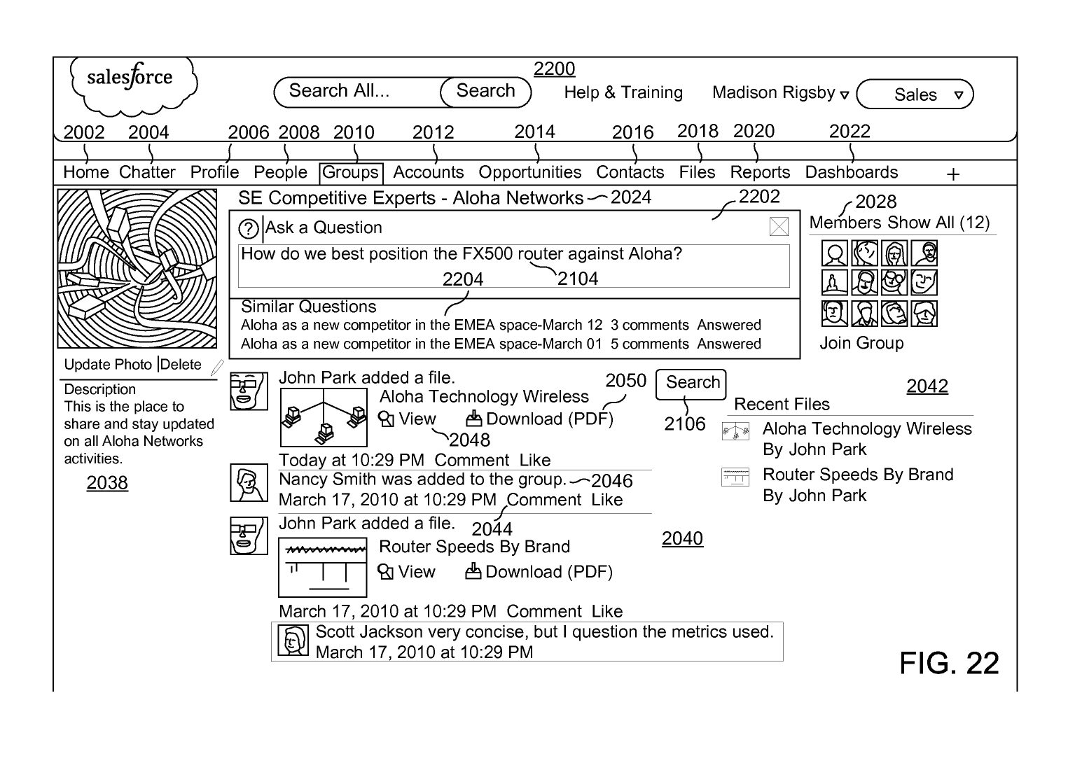

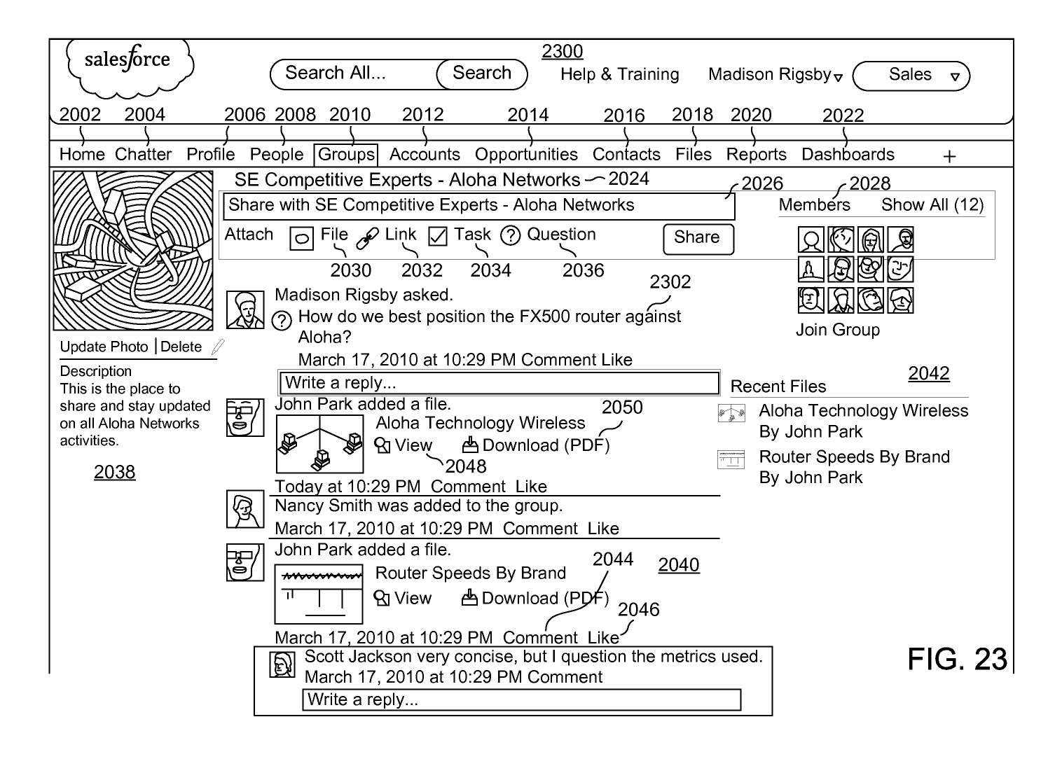

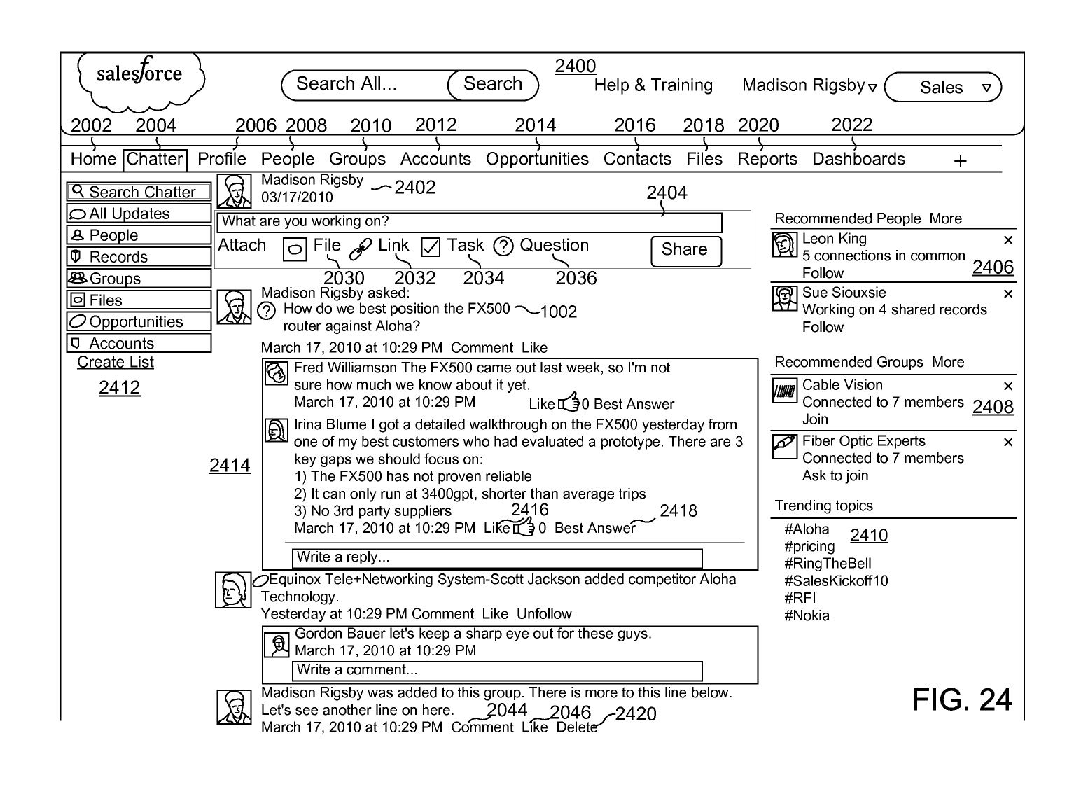

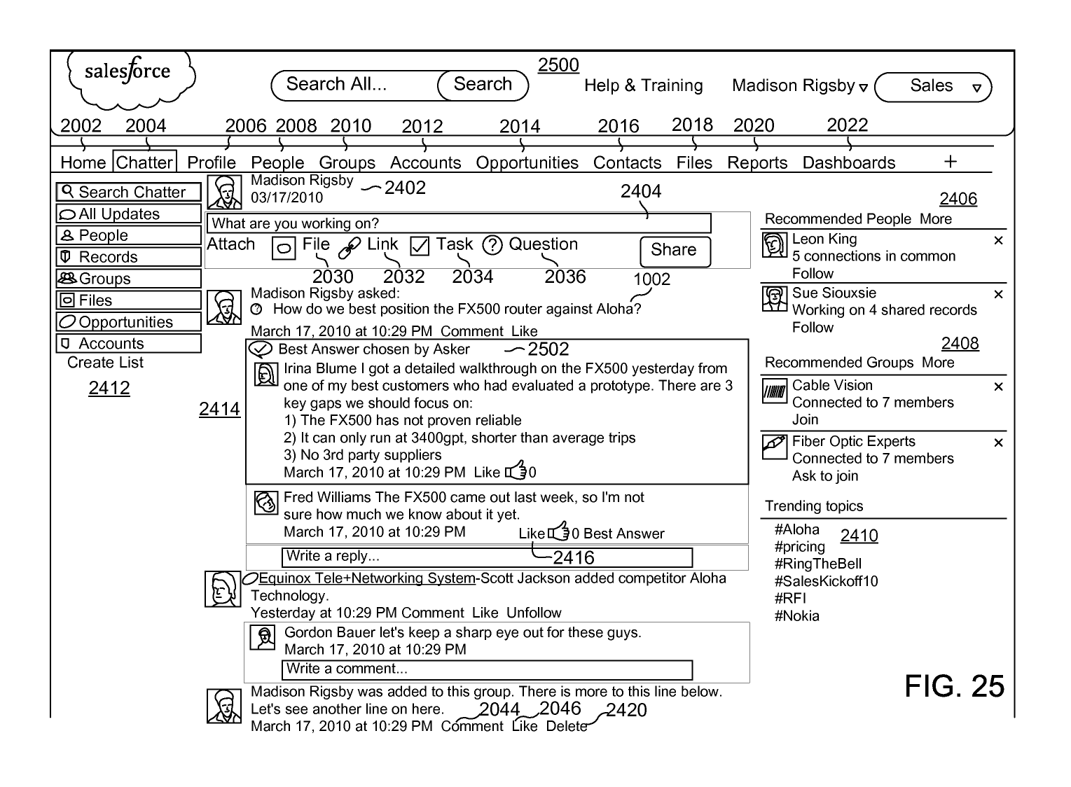

First a brief explanation of how FIGS. 8-19 relate to one another is presented which is followed by a detailed explanation of FIGS. 8-19. FIG. 8, FIG. 9, and FIG. 10 show screenshots of webpages that may be used to implement steps that may be involved in entering a question, viewing similar questions, posting the question in the forum, and receiving acknowledgement for posting the question in an embodiment. FIG. 11, FIG. 12, FIG. 13, FIG. 14 and FIG. 15 show the steps involved in posting a reply, receiving acknowledge for posting a reply, voting on a reply, voting best answer in an embodiment. Figures FIG. 16 and FIG. 17 show the steps in adding a new entry in the knowledge base management system for promotion and receiving acknowledgement for promoting the forum content in an embodiment. Figures FIG. 18 and FIG. 19 show an embodiment of a case being added to the customer case management system and receiving acknowledgement for escalating the case. FIG. 20, FIG. 21, FIG. 22 and FIG. 23 show the steps that may be involved in entering a question, viewing similar questions and posting the question in a forum in an embodiment. Figures FIG. 24 and FIG. 25 show the answer screen and best answer vote in an embodiment.

FIG. 8 shows screenshot 800 of an embodiment of question webpage. Screenshot 800 may include user name 802, help & training menu 804, community menu 806, home tab 808, contacts tab 810, companies tab 812, ideas tab 814, answers tab 816, cases tab 818, articles tab 820, reports tab 822, dashboards tab 824, search tab 826, article management tab 828, and ‘+’ menu 830. Screenshot 800 may also include the webpage title 832, my question & replies menu 834, help menu 836, search input box 838, search button 840, question input box 842, ask button 844, recently asked questions 846, list of forums 848 and reply link 850. In other embodiments, webpage 800 may not have all of the elements listed and/or may have other elements instead of or in addition to those listed.

Although user name 802, help & training menu 804, community menu 806, home tab 808, contacts tab 810, companies tab 812, ideas tab 814, answers tab 816, reports tab 822, dashboards tab 824, search tab 826, and ‘+’ menu 830 appear in the screenshots of each of FIG. 9, FIG. 10, FIG. 11, FIG. 12, FIG. 13, FIG. 14, FIG. 15, FIG. 16, FIG. 17, FIG. 18, and FIG. 19, since the description of user name 802, help & training menu 804, community menu 806, home tab 808, contacts tab 810, companies tab 812, ideas tab 814, answers tab 816, reports tab 822, dashboards tab 824, search tab 826, and ‘+’ menu 830 was discussed above, that description will not be repeated in FIG. 9, FIG. 10, FIG. 11, FIG. 12, FIG. 13, FIG. 14, FIG. 15, FIG. 16, FIG. 17, FIG. 18, and FIG. 19.

Similarly, cases tab 818, articles tab 820, article management tab 828, discussed above, appear in FIG. 9, FIG. 10, FIG. 14, FIG. 15, FIG. 16, FIG. 17, FIG. 18 and FIG. 19 and consequently the description of cases tab 818, articles tab 820, article management tab 828 will not be repeated in FIG. 9, FIG. 10, FIG. 14, FIG. 15, FIG. 16, FIG. 17, FIG. 18 and FIG. 19. Webpage title 832, discussed above, appears in figures FIG. 8, FIG. 9 and FIG. 10, and consequently the description of webpage title 832 will not be repeated in FIG. 9, FIG. 10, FIG. 14, FIG. 15, FIG. 16, FIG. 17, FIG. 18 and FIG. 19. My question & replies menu 834, help menu 836, search input box 838, search button 840, discussed above, also appear in figures FIG. 9, FIG. 10, FIG. 11, FIG. 12, FIG. 13, FIG. 14, FIG. 15, FIG. 17 and FIG. 19, and consequently the description of cases tab 818, articles tab 820, article management tab 828 will not be repeated in FIG. 9, FIG. 10, FIG. 14, FIG. 15, FIG. 16, FIG. 17, FIG. 18 and FIG. 19.

Screenshot 800 is a webpage that contains links for the user to access forum activities such as posting question, replying, escalating and promoting. Screenshot 800 includes information summarizing the recent forum activities and various forum topics.

User name 802 may display the user name of the current user. Help & training menu 804 may cause a webpage to appear that lists help and training in using the database system. Community menu 806, when selected, may list and provide links to various online communities such as sales and marketing. The home tab 808, when selected, may cause a webpage to appear that may be the user's webpage. Contacts tab 810, when selected, may cause a contacts webpage to appear that helps user in creating and managing contacts. The contacts webpage may allow the viewing and editing of detailed information about the contacts. Companies tab 812, when selected, may cause a companies-webpage to appear that list the organization's customers, competitors, and partners. The companies-webpage may have detailed information such as name, address, and phone numbers and related information such as opportunities, activities, cases, partners, contracts, and notes. Ideas tab 814, when selected, may causes a contacts-ideas-webpage to appear. The contacts-ideas-webpage is an online suggestion box that includes discussions and popularity rankings for a subject. Answer tab 816, when selected, may cause question screenshot 800 to appear. In the screenshot of FIG. 8 answer tab 816 is highlighted indicating that the tab is currently selected. Cases tab 818 when selected may cause a cases webpage to appear. The cases webpage may have customer's feedback, problems and/or questions posted. The cases webpage may be used to track and solve customers' issues. Articles tab 820, when selected, may cause an articles webpage to appear. The Article webpage may be used to search for published articles in the knowledge base. Reports tab 822, when selected, may cause a reports webpage to appear. The reports webpage may be used to generate various kinds of reports. Reports may be organized in rows and columns and/or displayed graphically as a chart. The reports may facilitate monitoring activities of an organization. Dashboards tab 824 when selected causes a dashboard webpage to appear. The dashboard webpage shows data from reports as visual components, which can be charts, gauges, or tables. Dashboard webpage may provide a snapshot of key metrics and performance indicators of an organization. Search tab 826, when selected, causes a search webpage to appear. The search webpage may include a search facility to search a user's database. Article management tab 828 may cause an article management webpage to appear. Article management webpage facilitates management of articles in publishing cycle including editing, publishing and archiving. ‘+’ tab 830 when selected causes all tabs webpage to appear. All tabs webpage displays all the available tabs and can used to customize screenshot 800.

Continuing with FIG. 8, in webpage 800 webpage, title 832 is an indication of the function of the webpage. My question & replies menu 834, may link to a webpage which lists all the questions and replies posted by the user indicated by user name 802. Help menu 836, when selected, may cause a help page to appear. The help page may give a description of the usage of the current webpage and/or or features on the current webpage. Search input box 838 may be a user interface for searching the forum with keywords entered in search input box. Search button 840, when selected, may send a message to the server to search forum 102 with the keywords in select input box 838. Question input box 842, may be the user interface for entering a question, such as a question related to the forum. Ask button 844, when selected, may send a message to the server to search the forum with keywords in the question input box 842. Recently asked questions 846, may list questions that were recently posted in the forum. Along with the question, the user name may also be displayed. List of forums 848 may list additional forum topics. Reply link 850, when selected, may cause a reply webpage to appear (which will be discussed below in conjunction with FIG. 11).

FIG. 9 shows screenshot 900 of an embodiment of question webpage displaying similar questions. Screenshot 900 may include question input box 842, recently asked questions 846, list of forums 848 and reply link 850 which were described in conjunction with FIG. 8. In addition screenshot 900 may include similar questions 902 and continue button 904. In other embodiments, screenshot 900 may not have all of the elements listed and/or may have other elements instead of or in addition to those listed.

Selecting ask button 844 may cause the server to search forum 102 for questions similar to the question in question box 842. FIG. 9 displays similar questions 902 that were discussed in the forum. Selecting a question from similar questions may cause the webpage to display the forum content related to the question. Continue button 904, when selected, may cause the server to post the question in forum 102.

FIG. 10 shows screenshot 1000 of an embodiment of a webpage displaying posting acknowledgement. Screenshot 1000 may include question input box 842, ask button 844, recently asked questions 846, list of forums 848 and reply link 850 which were described in conjunction with FIG. 8. In addition screenshot 1000 may include posting acknowledgement 1002. In other embodiments, screenshot 1000 may not have all of the elements listed and/or may have other elements instead of or in addition to those listed.

In FIG. 10, selecting the continue button 904 causes a webpage to appear with posting acknowledgement 1002 confirming that the question has been posted in the forum.

FIG. 11 shows screenshot 1100 of an embodiment of a webpage displaying reply. Selecting reply link 850 can cause screenshot 1100 to appear. Screenshot 1100 may include answers link 1102, forum link 1103, forum topic 1104, posted question 1106, number of replies 1108, sort replies 1110, reply button 1112 and reply box 1114. The remaining labeled elements of FIG. 11 were discussed in conjunction with FIG. 8. In other embodiments, screenshot 1100 may not have all of the elements listed and/or may have other elements instead of or in addition to those listed.

In FIG. 11, selecting answers link 1102, causes the answers webpage (e.g., of FIG. 8) to appear. Selecting forum link 1103 may cause the forum webpage to appear. Forum topic 1104, may display the current forum topic. Posted question 1106, may be the question posted in the forum for which a reply is being posted. Number of replies 1108, may indicate the number of replies that has been posted for posted question 1106. Selecting sort replies 1110 may cause the replies to be sorted in the order of newest to oldest or oldest to newest. Selecting reply button 1112 may cause the reply to be posted in the forum. Reply box 1114 is the input box for replies. User system can post replies to questions posted in the forum, via reply box 1114. For example, replies entered in input box 114 may be posted in forum 102 by selecting the reply button 1112.

FIG. 12 shows screenshot 1200 of an embodiment of a webpage displaying reply acknowledgement. Selecting reply button 1112 can cause screenshot 1200 to appear. Screenshot 1200 may include answers link 1102, forum link 1103, forum topic 1104, posted question 1106, number of replies 1108, sort replies 1110 and reply button 1112, which are described in conjunction with FIG. 11. Screenshot 1200 may include reply acknowledgement 1202. The remaining labeled elements of FIG. 12 were discussed in conjunction with FIG. 8. In other embodiments, screenshot 1200 may not have all of the elements listed and/or may have other elements instead of or in addition to those listed.

When a reply is posted by selecting the reply button 1112, the user system receives an acknowledgement. Acknowledgement 1202 may be the acknowledgement that is received when a reply is successfully posted.

FIG. 13 shows a screenshot 1300 of an embodiment of an answer webpage displaying votes to answers. Screenshot 1300 may include answers link 1102, forum link 1103, forum topic 1104, posted question 1106, number of replies 1108 and sort replies 1110 which are described in conjunction with FIG. 11. Screenshot 1300 can include like link 1302 and dislike link 1304. The remaining labeled elements of FIG. 13 were discussed in conjunction with FIG. 8. In other embodiments, screenshot 1300 may not have all of the elements listed and/or may have other elements instead of or in addition to those listed.

In FIG. 13 screenshot 1300 shows a reply being voted in an embodiment. After a reply is posted, the reply is visible to all users of forum 102. Users can vote on replies. In an embodiment, the user may indicate that the user likes the reply by choosing the like link 1302. In an embodiment, the user can choose to dislike the reply by selecting dislike link 1304.

FIG. 14 shows screenshot 1400 of an embodiment of a webpage displaying multiple replies. Screenshot 1400 may include answers link 1102, forum link 1103, forum topic 1104, posted question 1106, number of replies 1108 and sort replies 1110 which are described in conjunction with FIG. 11 like link 1302 and dislike link 1304 which are described in conjunction with FIG. 13. In addition, screenshot 1400 can include choose best answer link 1402, edit link 1404, delete link 1406, and promote article link 1408. The remaining labeled elements of FIG. 14 were discussed in conjunction with FIG. 8. In other embodiments, screenshot 1400 may not have all of the elements listed and/or may have other elements instead of or in addition to those listed.

In FIG. 14, screenshot 1400 shows a second reply being voted and options to vote or promote the reply. After a reply is posted, the reply is visible to all users of forum 102 and the reply count 1108 is updated. Users can vote on replies. In an embodiment, the user may indicate that the user likes or dislikes the answer by choosing the like link 1302 or dislike link 1304. By choosing the best answer link 1402, the authorized personnel can vote a reply to be the best answer. Other privileges of authorized personnel are editing the reply by choosing the edit link 1404 and deleting the reply by choosing the delete link 1406. The authorized personnel can also promote a reply to knowledge base management system by choosing promote to article link 1408. Selecting promote article link 1408 causes article management webpage to appear (which is described in conjunction with FIG. 16).

FIG. 15 shows screenshot 1500 of an embodiment of a webpage displayed with a best answer vote. Screenshot 1500 may include answers link 1102, forum link 1103, forum topic 1104 and posted question 1106 which are described in conjunction with FIG. 11, like link 1302 and dislike link 1304 which are described in conjunction with FIG. 13, edit link 1404, delete link 1406 and promote article 1408 which are described in conjunction with FIG. 14. In addition, screenshot 1500 can include best answer 1502. The remaining labeled elements of FIG. 15 were discussed in conjunction with FIG. 8. In other embodiments, screenshot 1400 may not have all of the elements listed and/or may have other elements instead of or in addition to those listed.

In FIG. 15, screenshot 1500 shows a reply which has been voted as best answer 1502.

FIG. 16 shows screenshot 1600 of an embodiment of article management webpage. Screenshot 1600 may include searchl602, title 1604, save button 1606, cancel 1608, title box 1610, recent items 1612, summary box 1614 and content box 1616. The remaining labeled elements of FIG. 16 were discussed in conjunction with FIG. 8. In other embodiments, screenshot 1600 may not have all of the elements listed and/or may have other elements instead of or in addition to those listed.

Selecting promote to article link 1408 causes article management webpage in FIG. 16 to appear. Search 1602 can be used to search in the article management. Webpage title 1604 may indicate the title of the webpage. Selecting the save button 1606 may cause the current contents of the title, summary and content to be saved as an article in the knowledge base management system. Selecting the cancel button 1608 may cause the disbanding of the process of an additional new article and may return the user to the previous webpage. In the embodiment of FIG. 16, the promoted forum content title appears in title box 1610. Recent items 1612, may list recent forum activities. Summary box 1614 may contain the questions and answers from the forum. Content box 1616 is an input for additional information that can be entered, so that it can be part of the knowledge article.

FIG. 17 shows screenshot 1700 of an embodiment of a webpage displaying article promotion. Screenshot 1700 may include answers link 1102, forum link 1103, forum topic 1104 and posted question 1106 which are described in conjunction with FIG. 11, like link 1302 and dislike link 1304 which are described in conjunction with FIG. 13, edit link 1404 and delete link 1406 which are described in conjunction with FIG. 14 and best answer vote 1502 which is described in conjunction with FIG. 15. In addition, screenshot 1700 can include acknowledge of article promotion 1702. The remaining labeled elements of FIG. 15 were discussed in conjunction with FIG. 8. In other embodiments, screenshot 1700 may not have all of the elements listed and/or may have other elements instead of or in addition to those listed.

Selecting save button 1606 causes an article to be added to knowledge base. Screenshot 1700 shows acknowledgement of the article promotion 1702.

FIG. 18 shows screenshot 1800 of an embodiment of a webpage displaying a case webpage with case escalation. Screenshot 1800 may include search 1602 and recent items 1612 described in conjunction with FIG. 16. In addition screenshot 1800 may include webpage title 1802, save button 1804 and case details 1806. The remaining labeled elements of FIG. 18 were discussed in conjunction with FIG. 8. In other embodiments, screenshot 1800 may not have all of the elements listed and/or may have other elements instead of or in addition to those listed.

FIG. 18 shows screenshot 1800 with a case being escalated. Webpage title 1802 indicates the title of the webpage. On selecting save button 1804, the question which was posted in forum 102 is entered in customer case management system 104 there by escalating the case. Case details 1806 contains all the details of the case which is being escalated including owner of the case, contact details, question and description of the case itself.

FIG. 19 shows screenshot 1900 of an embodiment of a webpage displaying case webpage with case escalation. Screenshot 1900 may include answers link 1102, forum link 1103, forum topic 1104, posted question 1106 and reply count 1108 which are described in conjunction with FIG. 11 and escalation acknowledgement 1902. The remaining labeled elements of FIG. 19 were discussed in conjunction with FIG. 8. In other embodiments, screenshot 1900 may not have all of the elements listed and/or may have other elements instead of or in addition to those listed.

Selecting save button 1804 causes a case to be added to customer case management system. Screenshot 1900 shows acknowledgement of a case being escalated in escalation acknowledgement 1902.

FIG. 20 shows screenshot 2000 which is an embodiment of forum 102. Screenshot 2000 may include home tab 2002, chatter tab 2004, profile tab 2006, people tab 2008, groups tab 2010, accounts tab 2012, opportunities tab 2014, contacts tab 2016, files tab 2018, reports tab 2020 and dashboards tab 2022. Screenshot 2000 may also include the title 2024, input box 2026, member list 2028, forum description 2038, forum conversation 2040, and recent files 2042. In addition webpage 2000 may include comment link 2044, like link 2046, attach file link 2030, attach-link link 2032, task link 2034, question link 2036, view link 2048 and download link 2050. The remaining labeled elements of FIG. 20 were discussed in conjunction with FIG. 8. In other embodiments, screenshot 2000 may not have all of the elements listed and/or may have other elements instead of or in addition to those listed.

Home tab 2002, chatter tab 2004, profile tab 2006, people tab 2008, groups tab 2010, accounts tab 2012, opportunities tab 2014, contacts tab 2016, files tab 2018, reports tab 2020 and dashboards tab 2022 also appears in figures FIG. 21, FIG. 22, FIG. 23, FIG. 24 and FIG. 25.

Screenshot 2000 is a webpage that provides the user with an interface for posting questions. The home tab 2002 is a tab that brings the user to a homepage (not shown) of the user's on-demand service. The chatter tab 2004 is a tab that causes a webpage to list workspaces (not shown) within the user's on-demand service which the user may select. The profile tab 2006 is a tab that causes user's profile page to appear, where the user can then view or edit the profile. People tab 2008 is a tab that takes the user to people's page. Selecting the people's tab causes a webpage to display a list of users in an organization. Groups tab 2010 is highlighted and presently selected by the user to display screenshot 2000. Groups are set of users. Selecting the groups tab 2010 causes to list of forums to appear. Selecting accounts tab 2012 causes the account management page to appear. The account management page helps in managing user accounts, and may contain links that provide a summary of information about specific accounts and/or may provide information about a group of accounts. Selecting opportunities tab 2014 takes the user to the sales and sale leads management pages, which help in managing new business opportunities. The contacts tab 2016 is a tab that helps users manage the contacts list. The Contacts list may help in managing by adding, deleting or editing contacts in an organization. The contacts list could contain names, email addresses and phone numbers of customers, vendors and potential customers and their activities on the multi-tenant database system. Selecting files tab 2018 takes the user to document storage area for managing documents. Reports tab 2020 is a tab that brings the user to a page where reports can be generated. Dashboards tab 2022 when selected causes dashboard webpage to appear. Dashboard webpage shows data from reports as visual components, which can be charts, gauges or tables. Dashboard webpage provides a snapshot of key metrics and performance indicators of an organization.

Continuing with FIG. 20, generally a forum has a topic to discuss. In screenshot 2000, the title 2024 may indicate the title of the forum. The user system (described below in conjunction with FIG. 26) may be ready to accept question at the user interface 2026. Input box 2026, is the user interface to enter question. The members of the forum may be listed in member list 2028. Along with the question, the user system can attach a file with the file link 2030. Hyperlinks can also be attached to the user input with the attach-link link 2032. The task link 2034 allows user to track specific actions the user plans to perform or has performed. The question link 2036 opens another input interface to enter question. Forum description 2038 is a description of the forum. Forum conversation 2040 is a display of a posted comment and/or question. Recent files 2042 lists files that were recently posted in the forum and the user that posted the files. Forum conversation 2040 can have comment link 2044, which allows the user to post a comment related to the question that was posted as part of the forum conversation. Like link 2046 may be used to post a vote indicating approval of the content. View link 2048 may be used for viewing the files that were attached. Download link 2050 may be used to download the files that were attached in the forum content. Although FIG. 20 shows a Group webpage on which questions and replies may be posed, in another embodiment, a Group webpage may be provided that does not provide users with the capability to post questions and replies.

FIG. 21 shows screenshot 2100 with posted question. Screenshot 2100 may include the title 2024, list of members 2028, forum description 2038, forum conversation 2040, recent files 2042, comment link 2044, like link 2046, view link 2048 and download link 2050 which were described in conjunction with FIG. 20. In addition, screenshot 2100 may include user interface 2102, question 2104 and share button 2106. In other embodiments, screenshot 2100 may not have all of the elements listed and/or may have other elements instead of or in addition to those listed.

Screenshot 2100 is a webpage with a question input interface. Groups tab 2010 is highlighted and presently selected by the user to display screenshot 2100. User interface 2102 may be the box within which a question may be inputted. Content entered in the user interface can be posted in the forum. Question 2104 displays the question to be posted in the forum. Selecting share button 2106 causes the question to be entered in the forum.

FIG. 22 shows screenshot 2200 which is an embodiment of forum 102 where the user question and similar questions are displayed. Screenshot 2200 may include title 2024, list of members 2028, forum description 2038, forum conversation 2040, recent files 2042, comment link 2044, like link 2046, view link 2048 and download link 2050 (described in conjunction with FIG. 20). In addition, screenshot 2200 may include user question 2104 and share button 2106 (described in conjunction with FIG. 21). Screenshot 2200 may include a user interface 2202 and similar questions 2204. In other embodiments, screenshot 2200 may not have all of the elements listed and/or may have other elements instead of or in addition to those listed.

Screenshot 2200 is a webpage which displays similar questions. Groups tab 2010 is highlighted and presently selected by the user to display screenshot 2200. The user system searches through the forum content for questions which are similar to the user's question and then displays them. User interface 2202 displays similar questions. Selecting similar questions 2204 causes a webpage with forum content related to the question to appear. Selecting share button 2106 posts the question in forum 102 and there by visible to all forum members.

FIG. 23 shows screenshot 2300 with user question posted. Screenshot 2300 may include title 2024, input interface 2026, list of members 2028, forum description 2038, forum conversation 2040, recent files 2042, comment link 2044, like link 2046, attach file link 2030, attach-link link 2032, task link 2034, question link 2036, view link 2048 and download link 2050. In addition screenshot 2300 may include posted question 2302. In other embodiments, screenshot 2300 may not have all of the elements listed and/or may have other elements instead of or in addition to those listed.

Screenshot 2300 is a webpage that displays user posted questions. The groups tab 2010 is highlighted and presently selected by the user to display screenshot 2300. The posted question 2302 is now visible to all users of the forum.

FIG. 24 shows screenshot of screenshot 2400 where users have posted answers. In this embodiment, screenshot 2400 may include comment link 2044, like link 2046, attach file link 2030, attach-link link 2032, task link 2034, question link 2036 (described in conjunction with FIG. 20). In an embodiment, screenshot 2400 may include posted question 2302(described in conjunction with FIG. 23), user name 2402, user interface 2404, recommended people 2406, recommended groups 2308, trending topics 2410, chatter menu 2412, delete link, answers to questions 2414, like vote 2416, best answer vote 2418, delete link 2420. In other embodiments, screenshot 2400 may not have all of the elements listed and/or may have other elements instead of or in addition to those listed.

Screenshot 2400 is a webpage which displays the chatter page. The chatter tab 2004 is highlighted and presently selected by the user to display chatter page in screenshot 2400. The chatter page displays the user activities in the forum. Such activities might include posting a question, posting an answer, following a conversation, commenting on posts and voting like or best answer. In an embodiment, the user name 2402 is displayed. User interface 2404 is an interface to post a question is available. The user system displays recommended people 2406, recommended groups 2408 and trending topics 2410. In screenshot 2400, the chatter page has additional links listed in chatter menu 2412. Posted reply 2414 is visible to all users. Users can choose to vote an answer choosing the like link 2416. The user who posted the question has additional privileges like voting best answer. Selecting best answer link 2418 marks the answer as best answer. Selecting the delete link 2420 by authorized personnel deletes the forum conversation.

FIG. 25 shows a screenshot of screenshot 2500 where posted answer has been voted as best answer. In this embodiment, screenshot 2500 may include comment link 2044, like link 2046, attach file link 2030, attach-link link 2032, task link 2034 and question link 2036(described in conjunction with FIG. 20). In addition screenshot 2500 may include user name 2402, user interface 2404, recommended people 2406, recommended groups 2308, trending topics 2410, chatter menu 2412, answers to questions 2414, like vote 2416 and delete link 2420 are described in conjunction with FIG. 24. Screenshot 2500 may also include best answer 2502. In other embodiments, screenshot 2500 may not have all of the elements listed and/or may have other elements instead of or in addition to those listed.

Screenshot 2500 is a webpage which displays the chatter page. The chatter tab 2004 is highlighted and presently selected by the user to display chatter page in screenshot 2500. Users can vote an answer as best. In an embodiment, the chatter page could show an answer which has been voted as best answer 2502.

### SYSTEM OVERVIEW

FIG. 26 illustrates a block diagram of an environment 2610 wherein an on-demand database service might be used. Environment 2610 may include user systems 2612, network 2614, system 2616, processor system 2617, application platform 2618, network interface 2620, tenant data storage 2622, system data storage 2624, program code 2626, and process space 2628. In other embodiments, environment 2610 may not have all of the components listed and/or may have other elements instead of, or in addition to, those listed above.

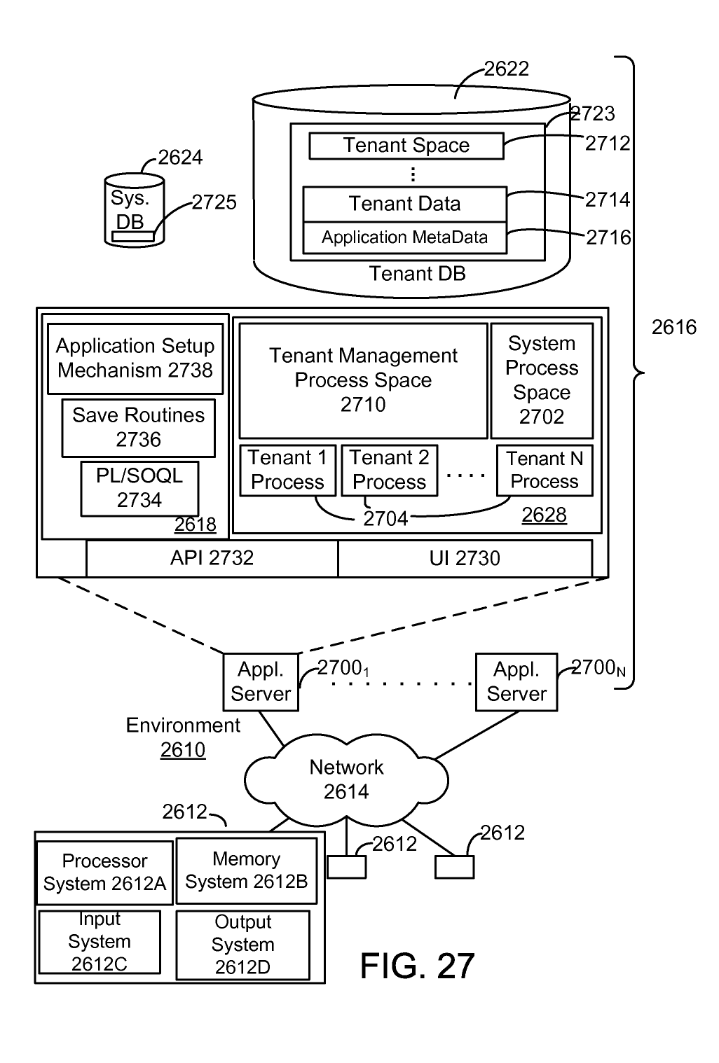

Environment 2610 is an environment in which an on-demand database service exists. User system 2612 may be any machine or system that is used by a user to access a database user system. For example, any of user systems 2612 can be a handheld computing device, a mobile phone, a laptop computer, a work station, and/or a network of computing devices. As illustrated in FIG. 26 (and in more detail in FIG. 27) user systems 2612 might interact via a network 2614 with an on-demand database service, which is system 2616.

An on-demand database service, such as system 2616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 2616” and “system 2616” will be used interchangeably herein. A database image may include one or more database objects. A relational database management system (RDMS) or the equivalent may execute storage and retrieval of information against the database object(s). Application platform 2618 may be a framework that allows the applications of system 2616 to run, such as the hardware and/or software, e.g., the operating system. In an embodiment, on-demand database service 2616 may include an application platform 2618 that enables creation, managing and executing one or more applications developed by the provider of the on-demand database service, users accessing the on-demand database service via user systems 2612, or third party application developers accessing the on-demand database service via user systems 2612.

The users of user systems 2612 may differ in their respective capacities, and the capacity of a particular user system 2612 might be entirely determined by permissions (permission levels) for the current user. For example, where a salesperson is using a particular user system 2612 to interact with system 2616, that user system has the capacities allotted to that salesperson. However, while an administrator is using that user system to interact with system 2616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 2614 is any network or combination of networks of devices that communicate with one another. For example, network 2614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 2612 might communicate with system 2616 using TCP/IP and, at a higher network level, use other common Internet protocols to communicate, such as HTTP, FTP, AFS, WAP, etc. In an example where HTTP is used, user system 2612 might include an HTTP client commonly referred to as a “browser” for sending and receiving HTTP messages to and from an HTTP server at system 2616. Such an HTTP server might be implemented as the sole network interface between system 2616 and network 2614, but other techniques might be used as well or instead. In some implementations, the interface between system 2616 and network 2614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 2616, shown in FIG. 26, implements a web-based customer relationship management (CRM) system. For example, in one embodiment, system 2616 includes application servers configured to implement and execute CRM software applications as well as provide related data, code, forms, webpages and other information to and from user systems 2612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 2616 implements applications other than, or in addition to, a CRM application. For example, system 2616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 2616.

One arrangement for elements of system 2616 is shown in FIG. 26, including a network interface 2620, application platform 2618, tenant data storage 2622 for tenant data 2723, system data storage 2624 for system data 2725 accessible to system 2616 and possibly multiple tenants, program code 2626 for implementing various functions of system 2616, and a process space 2628 for executing MTS system processes and tenant-specific processes, such as running applications as part of an application hosting service. Additional processes that may execute on system 2616 include database indexing processes.

Several elements in the system shown in FIG. 26 include conventional, well-known elements that are explained only briefly here. For example, each user system 2612 could include a desktop personal computer, workstation, laptop, PDA, cell phone, or any wireless access protocol (WAP) enabled device or any other computing device capable of interfacing directly or indirectly to the Internet or other network connection. User system 2612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 2612 to access, process and view information, pages and applications available to it from system 2616 over network 2614. Each user system 2612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 2616 or other systems or servers. For example, the user interface device can be used to access data and applications hosted by system 2616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 2612 and all of its components are operator configurable using applications, such as a browser, including computer code run using a central processing unit such as an Intel Pentium® processor or the like. Similarly, system 2616 (and additional instances of an MTS, where more than one is present) and all of their components might be operator configurable using application(s) including computer code to run using a central processing unit such as processor system 2617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 2616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 2616 is configured to provide webpages, forms, applications, data and media content to user (client) systems 2612 to support the access by user systems 2612 as tenants of system 2616. As such, system 2616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 27 also illustrates environment 2610. However, in FIG. 27 elements of system 2616 and various interconnections in an embodiment are further illustrated. FIG. 27 shows that user system 2612 may include processor system 2612A, memory system 2612B, input system 2612C, and output system 2612D. FIG. 26 shows network 2614 and system 2616. FIG. 27 also shows that system 2616 may include tenant data storage 2622, tenant data 2723, system data storage 2624, system data 2725, User Interface (UI) 2730, Application Program Interface (API) 2732, PL/SOQL 2734, save routines 2736, application setup mechanism 2738, applications servers 2700₁-2700_{N}, system process space 2602, tenant process spaces 2604, tenant management process space 2610, tenant storage area 2612, user storage 2614, and application metadata 2616. In other embodiments, environment 2610 may not have the same elements as those listed above and/or may have other elements instead of, or in addition to, those listed above.

User system 2612, network 2614, system 2616, tenant data storage 2622, and system data storage 2624 were discussed above in FIG. 26. Regarding user system 2612, processor system 2612A may be any combination of one or more processors. Memory system 2612B may be any combination of one or more memory devices, short term, and/or long term memory. Input system 2612C may be any combination of input devices, such as one or more keyboards, mice, trackballs, scanners, cameras, and/or interfaces to networks. Output system 2612D may be any combination of output devices, such as one or more monitors, printers, and/or interfaces to networks. As shown by FIG. 26, system 2616 may include a network interface 2620 (of FIG. 26) implemented as a set of HTTP application servers 2700, an application platform 2618, tenant data storage 2622, and system data storage 2624. Also shown is system process space 2602, including individual tenant process spaces 2604 and a tenant management process space 2610. Each application server 2700 may be configured to tenant data storage 2622 and the tenant data 2723 therein, and system data storage 2624 and the system data 2725 therein to serve requests of user systems 2612. The tenant data 2723 might be divided into individual tenant storage areas 2612, which can be either a physical arrangement and/or a logical arrangement of data. Within each tenant storage area 2612, user storage 2614 and application metadata 2616 might be similarly allocated for each user. For example, a copy of a user's most recently used (MRU) items might be stored to user storage 2614. Similarly, a copy of MRU items for an entire organization that is a tenant might be stored to tenant storage area 2612. A UI 2730 provides a user interface and an API 2732 provides an application programmer interface to system 2616 resident processes to users and/or developers at user systems 2612. The tenant data and the system data may be stored in various databases, such as one or more Oracle™ databases.

Application platform 2618 includes an application setup mechanism 2738 that supports application developers' creation and management of applications, which may be saved as metadata into tenant data storage 2622 by save routines 2736 for execution by subscribers as one or more tenant process spaces 2604 managed by tenant management process 2610 for example. Invocations to such applications may be coded using PL/SOQL 2734 that provides a programming language style interface extension to API 2732. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 2616 for the subscriber making the invocation and executing the metadata as an application in a virtual machine.

Each application server 2700 may be communicably coupled to database systems, e.g., having access to system data 2725 and tenant data 2723, via a different network connection. For example, one application server 2700₁ might be coupled via the network 2614 (e.g., the Internet), another application server 2700_{N-1} might be coupled via a direct network link, and another application server 2700_{N} might be coupled by yet a different network connection. Transfer Control Protocol and Internet Protocol (TCP/IP) are typical protocols for communicating between application servers 2700 and the database system. However, it will be apparent to one skilled in the art that other transport protocols may be used to optimize the system depending on the network interconnect used.

In certain embodiments, each application server 2700 is configured to handle requests for any user associated with any organization that is a tenant. Because it is desirable to be able to add and remove application servers from the server pool at any time for any reason, there is preferably no server affinity for a user and/or organization to a specific application server 2700. In one embodiment, therefore, an interface system implementing a load balancing function (e.g., an F5 Big-IP load balancer) is communicably coupled between the application servers 2700 and the user systems 2612 to distribute requests to the application servers 2700. In one embodiment, the load balancer uses a least connections algorithm to route user requests to the application servers 2700. Other examples of load balancing algorithms, such as round robin and observed response time, also can be used. For example, in certain embodiments, three consecutive requests from the same user could hit three different application servers 2700, and three requests from different users could hit the same application server 2700. In this manner, system 2616 is multi-tenant, wherein system 2616 handles storage of, and access to, different objects, data and applications across disparate users and organizations.

As an example of storage, one tenant might be a company that employs a sales force where each salesperson uses system 2616 to manage their sales process. Thus, a user might maintain contact data, leads data, customer follow-up data, performance data, goals and progress data, etc., all applicable to that user's personal sales process (e.g., in tenant data storage 2622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 2616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 2616 might also maintain system level data usable by multiple tenants or other data. Such system level data might include industry reports, news, postings, and the like that are sharable among tenants.

In certain embodiments, user systems 2612 (which may be client systems) communicate with application servers 2700 to request and update system-level and tenant-level data from system 2616 that may require sending one or more queries to tenant data storage 2622 and/or system data storage 2624. System 2616 (e.g., an application server 2700 in system 2616) automatically generates one or more SQL statements (e.g., one or more SQL queries) that are designed to access the desired information. System data storage 2624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/8128,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### METHOD FOR USING THE ENVIRONMENT (FIGS. 26 AND 27)

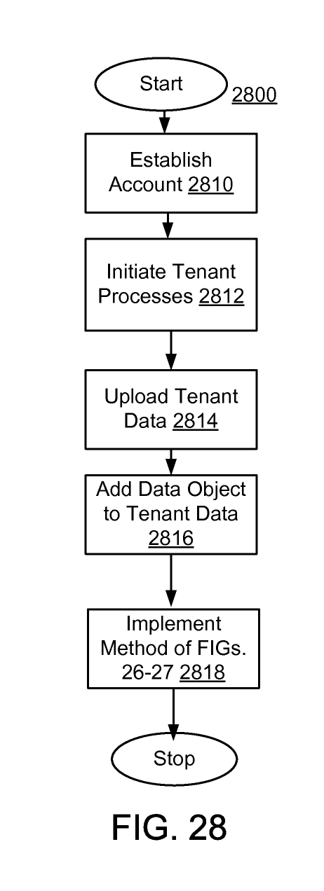

FIG. 28 shows a flowchart of an example of a method 2800 of using environment 2610. In step 2810, user system 2612 (FIGS. 26 and 27) establishes an account. In step 2812, one or more tenant process space 2704 (FIG. 27) are initiated on behalf of user system 2612, which may also involve setting aside space in tenant space 2712 (FIG. 27) and tenant data 2714 (FIG. 27) for user system 2612. Step 2812 may also involve modifying application metadata to accommodate user system 2612. In step 2814, user system 2612 uploads data. In step 2816, one or more data objects are added to tenant data 2714 where the data uploaded is stored. In step 2818, the methods associated with FIGS. 26-27 may be implemented. In another embodiment, although depicted as distinct steps in FIG. 28, steps 2802-2818 may not be distinct steps. In other embodiments, method 2800 may not have all of the above steps and/or may have other steps in addition to, or instead of, those listed above. The steps of method 2800 may be performed in another order. Subsets of the steps listed above as part of method 2800 may be used to form their own method.

### METHOD FOR CREATING THE ENVIRONMENT (FIGS. 26 AND 27)

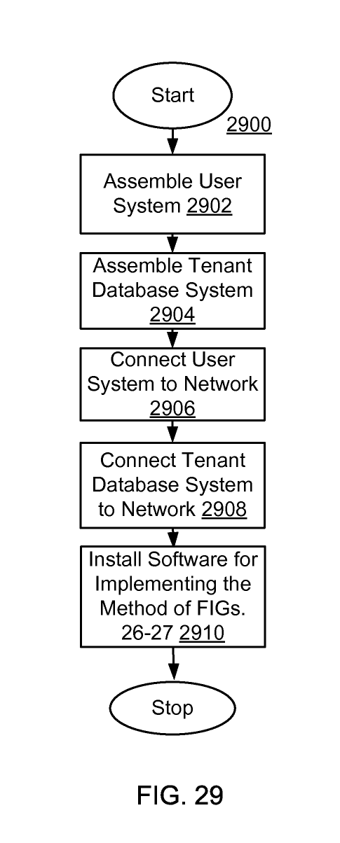

FIG. 29 is a method of making environment 2610, in step 2902, user system 2612 (FIGS. 26 and 27) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 2904, system 2616 (FIGS. 26 and 27) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 2616 may include installing application platform 2618, network interface 2620, tenant data storage 2622, system data storage 2624, system data 2725, program code 2626, process space 2628, UI 2730, API 2732, PL/SOQL 2734, save routine 2736, application setup mechanism 2738, applications servers 100₁-100_{N}, system process space 102, tenant process spaces 2704, tenant management process space 110, tenant space 2712, tenant data 2714, and application metadata 116 (FIG. 27).

In step 2906, user system 2612 is communicatively coupled to network 2704. In step 2908, system 2616 is communicatively coupled to network 2704 allowing user system 2612 and system 2616 to communicate with one another (FIG. 27). In step 2910, one or more instructions may be installed in system 2616 (e.g., the instructions may be installed on one or more machine readable media, such as computer readable media, therein) and/or system 2616 is otherwise configured for performing the steps of methods associated with FIGS. 26-27. In an embodiment, each of the steps of method 2900 is a distinct step. In another embodiment, although depicted as distinct steps in FIG. 29, steps 2902-2910 may not be distinct steps. In other embodiments, method 2900 may not have all of the above steps and/or may have other steps in addition to, or instead of, those listed above. The steps of method 2900 may be performed in another order. Subsets of the steps listed above as part of method 2900 may be used to form their own method.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### EXTENSIONS AND ALTERNATIVES

In an alternate embodiment, the data presented to the server to decide escalation/promotion is in a central location accessible to authorized personnel. In another embodiment, data could be provided in a tabular format such that it is easy to analyze.

In another embodiment, the process of escalation or promotion can be partially or fully automated, subject to review of authorized personnel. For example, after the server has performed escalation/promotion may authorized personnel review the forum to determine whether the automated escalation/promotion were appropriate or whether other escalations/promotions should be made in addition or instead of the automated escalations/promotions. The server can provide data necessary for escalation or promotion to the software and the software can decide to escalate/promote or not. In an embodiment, the automation software can add an entry in the knowledge base with the forum content and inform the forum and the authorized personnel about the action. In an embodiment, the automation software can escalate the question to customer case management system by adding a new case in the customer case management system and informing the forum and authorized personnel about the new case. The software can also link the case/article to the question in the forum.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method for adding content of a web forum to at least one customer support database in a multi-tenant database system, comprising:
sending, by a host system including one or more machines having a processor system having one or more processors, at least one webpage having a user interface, the webpage being associated with the web forum and the webpage including a conversation between users of the web forum;
receiving, at the host system, an update to the webpage having an update to the conversation;
adding, by the processor system, an entry in the customer support database, the entry being related to the conversation;
linking, by the host machine, the conversation to the entry;
adding, by the host machine, to the web forum an indication that the content was entered; and sending, from the host machine, a webpage having the indication, the webpage being associated with the web forum.

2. The method of claim 1, further comprising collecting, by the host machine, information to determine whether content of the conversation should be entered in the customer support database.

3. The method of claim 2, the customer support database being a customer case management system, which is a database storing content related to customer support issues.

4. The method of claim 3, the information includes at least the name of the author of a question related to the entry, the question appearing on the webpage.

5. The method of claim 4, the author of the question appears on the webpage below the question.

6. The method of claim 3, the information includes at least customer attributes of the user system posting the question in the web forum.

7. The method of claim 3, the information includes at least a duration of time since a last reply to a question on the webpage.

8. The method of claim 7, the information that was collected includes at least an indication of how many times the webpage was viewed.

9. The method of claim 7, the information that was collected includes at least the duration since the last reply to a question that appears on the webpage.

10. The method of claim 2, the customer support database being a knowledge base management system, which is a repository storing articles and content related to solutions to customer issues.

11. The method of claim 10, the link for voting to dislike an answer being juxtaposed to a link for voting to like an answer.

12. The method of claim 2, the information that was collected includes at least an indication of how many votes were received for an answer to a question that appears on the webpage.

13. The method of claim 1, the at least one webpage including a link for voting a like an answer.

14. The method of claim 1, the at least one webpage including a link for voting a dislike an answer.

15. The method of claim 1, the at least one webpage including a link for indicating that a particular answer is best.

16. The method of claim 1, sending only to user machines associated with authorized personnel a link, which when activated enters content of the web forum into the customer support database.

17. The method of claim 1,
the at least one customer support database includes at least
a customer case management system, which is a system for storing content related to customer support issues, and
a knowledge base management system, which is a repository storing articles and content related to solutions to customer issues; and
the at least one webpage that was sent having information that is relevant for determining whether content of the conversation should be entered in the customer case management system and the knowledge base management system, the information including at least an indication of a duration of time since a last reply to a question on the webpage;
an indication of how many votes were received for an answer to a question that appears on the webpage; and
an indication of how many times the webpage was viewed;
the multitenant database system also storing information about customer attributes in a location that is accessible to a machine that is associated with a person authorized to perform the adding of the entry;
the method further comprising
sending only to user machines associated with authorized personnel a link, which when activated enters content of the web forum into the customer support database.

18. The method of claim 1, a number indicating number of votes for a reply appear on the webpage below the reply.

19. A machine comprising:
a processor system including one or more processors;
a storage system having one or more machine readable media, storing thereon one or more instructions for implementing a web application that includes one or more instructions that cause the processor system to perform a method including at least:
sending, by a host system including one or more machines having a processor system having one or more processors, at least one webpage having a user interface, the webpage being associated with the web forum and the webpage including a conversation between users of the web forum;
receiving, at the host system, an update to the webpage having an update to the conversation;
adding, by the processor system, an entry in the customer support database, the entry being related to the conversation;
linking, by the host machine, the conversation to the entry;
adding, by the host machine, to the web forum an indication that the content was entered; and
sending, from the host machine, a webpage having the indication, the webpage being associated with the web forum.

20. A machine-readable medium carrying one or more sequences of instructions for implementing a method for providing an interface for object relationships, the method comprising:
sending, by a host system including one or more machines having a processor system having one or more processors, a webpage with a user interface , the webpage being associated with the web forum and the webpage including a conversation between users of the web forum;
receiving, at the host system, an update to the webpage having an update to the conversation;
adding, by the processor system, an entry in the customer support database, the entry being related to the conversation;
linking, by the host machine, the conversation to the entry;
adding, by the host machine, to the web forum an indication that the content was entered; and
sending, from the host machine, a webpage having the indication, the webpage being associated with the web forum.
